(19) United States
(12) Patent Application Publication
(10) Pub. No.: US 2009/0045691 A1
(43) Pub. Date: Feb. 19, 2009

(54) FIELD CONTROLLABLE ROTATING ELECTRIC MACHINE SYSTEM WITH MAGNETIC EXCITATION PART

(75) Inventor: Yoshikazu ICHIYAMA, Kyoto (JP)

Correspondence Address: DITTHAVONG MORI & STEINER, P.C., 918 Prince St., Alexandria, VA, 22314, US

(73) Assignee: Kura Laboratory Corporation, Kyoto (JP)

(21) Appl. No.: 12/024,911

(22) Filed: Feb. 1, 2008

(30) Foreign Application Priority Data
Aug. 17, 2007 (JP) 2007-212674
Oct. 29, 2007 (JP) 2007-279975
Dec. 4, 2007 (JP) 2007-313140

(51) Int. Cl. H02K 21/00; H02K 3/18; H02P 9/00

(52) U.S. Cl. 310/181; 310/191; 322/29

(57) ABSTRACT

In a magnet-exciting rotating electric machine, a magnetic excitation part for supplying a magnetic flux between a magnetic salient pole and an armature is composed to be divided into two so as to be capable of being relatively displaced. In this structure, the magnetic flux from the field magnet is divided into a main magnetic flux pathway that passes through the armature side and a bypass magnetic flux pathway that does not pass through the armature, and thereby, the magnetic flux of the main magnetic flux pathway is changed. The magnetic resistances of the main magnetic flux pathway and the bypass magnetic flux pathway are composed to be approximately equal, and then a magnetic force preventing the relative displacement is suppressed small. Thereby, the rotating electric machine system and the magnetic field control method in which magnetic field control is easy are provided.

### CROSS-REFERENCE TO RELATED APPLICATIONS

The present application claims priority under 35 U.S.C. §119 to Japanese Patent Application Nos. 2007-212674 filed Aug. 17, 2007, 2007-279975 filed Oct. 29, 2007, and 2007-313140 filed Dec. 4, 2007. The contents of these applications are incorporated herein by reference in their entirety.

### BACKGROUND OF THE INVENTION

1. Field of the Invention

The present invention relates to rotating electric machines such as electric generators and electric motors having a permanent magnet.

2. Description of the Related Art

Rotating electric machine apparatuses, such as an electric generator for generating electric power electromagnetically by relative rotation between a permanent magnet and an armature, or an electric motor for generating relative rotation between a permanent magnet and an armature by interaction between the permanent magnet and a magnetic field generated by current supplied to the armature, are excellent in energy efficiency and have been widely used routinely along with development of permanent magnets. However, in both electric motors and electric generators, optimum power is not always obtained in a wide rotational speed range because of constant magnetic field strength from the field magnet.

In the case of the electric motor, the control thereof becomes difficult in a high-speed rotational region because the back electromotive force (power generation voltage) becomes too high, and therefore, various methods for weakening the field strength as field-weakening control have been proposed. Moreover, in the case of the electric generator, a constant-voltage electric generator by only field current control or a constant-voltage circuit in which the power generation voltage is made to be constant by a semiconductor has been exclusively used so that the power generation voltage is made to be a predetermined level in a wide rotational-speed range.

In the electric motor, field-weakening control by current phase control has been widely adopted, but energy loss is large because current flows that does not directly contribute to the rotation. When current excitation for the control is used with a permanent magnet excitation, the structure of the rotating electric machine becomes complex and additionally energy loss is involved. Furthermore, in the case of the electric generator, there has been a problem that cost of constant-voltage electronic circuit with a large electric power is large. Under such a circumstance, measures for reducing the cost of the entire apparatus while binding the electronic-circuit control to a minimum by devising the structure of the rotating electric machine apparatus have been required for a long time, and various proposals have been made.

In U.S. Pat. No. 3,713,015, there is described an alternating current generator in which a permanent magnet rotor is divided into two and the two permanent magnet rotors are relatively displaced in the circumferential direction to effectively control the field strength. There is an advantage that the energy loss for the control is small because the relative displacement can be maintained mechanically, but there is a disadvantage that eddy-current loss is large in a high-speed rotational region because the amount of the magnetic flux flowing into the armature is constant.

In Japanese Unexamined Patent Publication (Kokai) No. 2004-320864 and No. 2004-328944, there are described methods for controlling a magnetic field strength by changing magnetic resistance in a magnetic circuit including the field magnet. Furthermore, in U.S. Pat. No. 4,885,493, Japanese Unexamined Patent Publication (Kokai) No. 2004-357357 and No. 2006-246662, methods for making the field magnet short have been described.

The contents of U.S. Pat. Nos. 3,713,015 and 4,885,493, Japanese Unexamined Patent Publication Nos. 2004-320864, 2004-328944, 2004-357357, and No. 2006-246662 are incorporated herein by reference in their entirety.

In general, when the magnetic circuit including the magnet has a movable part, there is a magnetic force of displacing the movable part to the direction in which the magnetic flux quantity flowing through the magnetic circuit becomes large (the direction in which the magnetic resistance becomes small). The field magnet is a source for generating force or generating power in the rotating electric machine apparatus, and the magnetic force thereof is proportional to the output of the rotating electric machine in the proposed example of the rotating electric machine apparatus for controlling the magnetic resistance of the magnetic circuit or for short-circuiting the field magnet by mechanical displacement. A large force is required for the displacement control of the mechanism and vibration or hunting of the members is caused to make it difficult to perform the accurate control. Furthermore, a large-power actuator, a control mechanism involving excessive mechanical strength, and so forth are required, and therefore, realization of the apparatus involves difficulty.

### SUMMARY OF THE INVENTION

Accordingly, an embodiment of the present invention advantageously provides a method for controlling a magnetic field strength, a rotating electric machine apparatus, and a rotating electric machine system, by which field-weakening control becomes easy, while satisfying the following conditions: (1) mechanical means are adopted for maintaining the operating condition; (2) generation of a magnetic force disturbing operation of the mechanical means in the field control can be suppressed; (3) the magnetic flux on the armature side can be even controlled in zero neighborhoods for eddy current loss evasion; and furthermore, desirably, (4) the entire magnetic material of the magnetic salient pole can be released for generation of reluctance torque by controlling the magnetic flux flowing through the magnetic salient pole opposed to the armature to be approximately zero, and so forth.

An embodiment of a rotating electric machine apparatus according to the present invention includes: at least a surface magnetic pole part and an armature that are opposed to each other concentrically to an axis in a radial direction or in an axial direction and that are disposed to be capable of relatively rotating; wherein the armature has an armature coil at least; the surface magnetic pole part has at least a plurality of magnetic salient poles disposed in a circumferential direction oppositely to the armature; the magnetic salient poles in the surface magnetic pole part are classified to one or two group(s) according to polarity(s) to be magnetized; each of the classified group(s) of the magnetic salient poles are magnetically excited by a magnetic excitation part; the magnetic excitation part has a field magnet and controls, by mechanical displacement, magnetic flux amount supplied to the magnetic salient poles.

A main magnetic flux pathway in which a magnetic flux circulates through the magnetic salient poles and the armature and a bypass magnetic flux pathway in which a magnetic flux circulates within the magnetic excitation part are connected to the field magnet in parallel in the magnetic excitation part, and a magnetic resistance of the bypass magnetic flux pathway is set to be approximately equal to a magnetic resistance of the main magnetic flux pathway, and the magnetic flux from the field magnet is divided into the main magnetic flux pathway and the bypass magnetic flux pathway by mechanical displacement to control an amount of the magnetic flux flowing between the magnetic salient pole and the armature.

One embodiment of the magnetic excitation part is as follows: an end of the field magnet serves as a first magnet end and the other end of the field magnet serves as a second magnet end, and the first magnet end is opposed to a main magnetic pole connected with the main magnetic flux pathway and to a bypass magnetic pole connected with the bypass magnetic flux pathway, and the field magnet and a combination of the main magnetic pole and the bypass magnetic pole are composed so as to be capable of being relatively displaced with maintaining a sum of an area of the first magnet end opposed to the main magnetic pole and an area of the first magnet end opposed to the bypass magnetic pole to be constant.

A characteristic in an embodiment of a rotating electric machine apparatus of the present invention is that the magnetic flux from the field magnet is controlled to be divided into the main magnetic flux pathway and the bypass magnetic flux pathway by mechanical displacement in the above-described structure. Even if the magnetic flux amount from the field magnet is changed by this composition, risk which the field magnet is demagnetized is avoidable. Moreover, the total amount of the magnetic flux which flows from the field magnet by setting magnetic resistance of two of magnetic flux pathways as predetermined conditions is always made constant, and then magnetic force preventing the mechanical displacement can be maintained small. Thereby, the field control in the main magnetic flux pathway can be smoothly performed.

It is important to establish a magnetic resistance of the bypass magnetic flux pathway is set to be approximately equal to a magnetic resistance of the main magnetic flux pathway, and the magnetic power disturbing the displacement can be suppressed small and the field control can be carried out smoothly. The meaning which is “approximately equal” is to establish both magnetic resistance equally so that the magnetic power may be suppressed below the output of the actuator used for the displacement.

Various means can be applied to a means for performing relative displacement between the field magnet and the combination of the main magnetic pole and the bypass magnetic pole. For example, there are a mechanical means for preliminarily setting by hand as a semi-fixed mechanism, a governor mechanism for moving the movable magnetic pole part by utilizing a centrifugal force, a mechanical means having an actuator in a rotor in the case that a field magnet part is in the rotor side, a mechanical means for performing displacement from the outside of the rotor, and so forth.

In the rotating electric machine apparatus, there are a structure in which the field magnet part rotates and the armature stands still and an opposite structure thereof, a structure in which the cylindrical armature and the field magnet part are opposed to each other in the radial direction through an air gap, and a structure in which the approximately disc-like armature and the field magnet part are opposed in the axial direction through an air gap. Embodiments of the present invention can also be applied to any one of the above-described structures having the field magnet part of a permanent magnet excitation.

Moreover, the rotating electric machine is an electric motor when a current to the armature coils is input and the rotational force is output, and the rotating electric machine is an electric generator when the rotational force is input and the current is output from the armature coils. Optimal magnetic structures exist in the electric motor or the electric generator, but are reversible, and the rotating electric machine apparatus can be applied to both of the electric motor and the electric generator.

One of the specific means to correct the magnetic resistance of the main magnetic flux pathway includes the following means. When changing the field strength, a constant current load is connected to an armature coil so that predetermined electric current is made to flow by the induced voltage. And thereby the magnetic resistance of the main magnetic flux pathway is adjusted effectively so that the magnetic power which disturbs the above-mentioned relative displacement may be made small.

Since the induced voltage passes the current which bars change of the magnetic flux which interlinks with the armature coil, it adjusts the magnetic resistance of the main magnetic flux pathway so that it may become equal to the magnetic resistance of the bypass magnetic flux pathway as a size effectively.

One of the specific means to correct the magnetic resistance of the main magnetic flux pathway includes the following means: when changing the field strength, the predetermined current which drives a rotor in acceleration or the slowdown direction is supplied to the armature coil, and the magnetic resistance of the main magnetic flux pathway is effectively adjusted so that the magnetic force which disturbs the above-mentioned relative displacement may be made small.

The magnetic flux amount becomes large and small, respectively, when accelerating and slowing down the rotor. Exploiting these phenomena, magnetic resistance of the main magnetic flux pathway can be effectively adjusted so that it may become equal to magnetic resistance of the bypass magnetic flux pathway.

One of the specific structures of the magnetic pole of the surface magnetic pole part and the magnetic excitation part disposition includes the following structure: the surface magnetic pole part is characterized in that the magnetic salient poles and the non-magnetic portions are opposed to the armature, and disposed in the rotor side as a structure of being disposed one after the other in the circumferential direction, and the magnetic excitation part is disposed in the static side or the rotor side, and the magnetic salient pole of the surface magnetic pole part and the armature are magnetically connected to the main magnetic pole and the second magnet end, respectively.

One of the specific structures of the magnetic pole of the surface magnetic pole part and the magnetic excitation part disposition further includes the following structure. The surface magnetic pole part is characterized in that the magnetic salient poles and the non-magnetic portions are opposed to the armature, and disposed in the rotor side as a structure of being disposed one after the other in the circumferential direction, and the adjacent magnetic salient poles are extended each other to different axial directions, and extended magnetic salient pole parts serve as a first extension part and a second extension part according to the extended axial direction, and the magnetic excitation part is disposed in the static side or the rotor side so as to magnetize the contiguous magnetic salient poles to be different polarities from each other through the first extension part and the second extension part.

One of the specific structures of the magnetic pole of the surface magnetic pole part and the magnetic excitation part disposition further includes the following structure: the surface magnetic pole part is characterized in that the magnetic salient poles and permanent magnets are opposed to the armature, and disposed in the rotor side as a structure of being disposed one after the other in the circumferential direction, and the adjacent magnetic salient poles are magnetized differently, and the adjacent magnetic salient poles are extended each other to different axial directions, and extended magnetic salient pole parts serve as a first extension part and a second extension part according to the extended axial direction, and one or two of a magnetic excitation part is disposed in a static side or in a rotor side so that the direction of the magnetization whose the permanent magnet magnetizes the magnetic salient pole and the direction of the magnetization whose the excitation pole part magnetizes the magnetic salient pole through the first extension part and the second extension part may be coincided.

In this structure, the magnetized directions of the magnetic salient poles by the permanent magnet and by the magnetic excitation part are set to be the same, therefore the magnetic force preventing the mechanical displacement for dividing the magnetic flux will not appear.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a longitudinal sectional view of a rotating electric machine apparatus according to a first embodiment of the present invention;

FIG. 2 is a sectional view showing an armature and a rotor of the rotating electric machine apparatus shown in FIG. 1;

FIGS. 3(a) and 3(b) are plan views showing a magnetic excitation part of the rotating electric machine apparatus shown in FIG. 1;

FIGS. 4(a) and 4(b) are plan views showing a main magnetic pole and a bypass magnetic pole that are rotationally displaced in the rotating electric machine apparatus shown in FIG. 1;

FIG. 5 is a sectional view showing a part of a displacement control means of the rotating electric machine apparatus shown in FIG. 1;

FIG. 6 is a time chart of a rotating electric machine system for performing magnetic field control;

FIG. 7 is a block diagram of a rotating electric machine system for performing field-weakening control;

FIG. 8 is a longitudinal sectional view of a rotating electric machine apparatus according to a second embodiment of the present invention;

FIG. 9 is a sectional view showing an armature and a rotor of the rotating electric machine apparatus shown in FIG. 8;

FIG. 10 is a longitudinal sectional view showing the rotor and a magnetic excitation part of the rotating electric machine apparatus shown in FIG. 8;

FIG. 11 is a sectional view showing the magnetic excitation part of the rotating electric machine apparatus shown in FIG. 8;

FIG. 12 is a longitudinal sectional view of a rotating electric machine apparatus according to a third embodiment of the present invention;

FIG. 13 is a sectional view showing an armature and a rotor of the rotating electric machine apparatus shown in FIG. 12;

FIG. 14 is a perspective view showing the rotor, a first extension part and a second extension part of the rotating electric machine apparatus shown in FIG. 12;

FIG. 15 is a sectional view of a rotating electric machine apparatus according to a fourth embodiment of the present invention;

FIG. 16 is a longitudinal sectional view of a rotating electric machine apparatus according to a fifth embodiment of the present invention;

FIG. 17 is a sectional view showing an armature and a rotor of the rotating electric machine apparatus shown in FIG. 16;

FIG. 18 is a perspective view showing the rotor, a first extension part, a second extension part and a magnetic excitation part of the rotating electric machine apparatus shown in FIG. 16;

FIG. 19 is a longitudinal sectional view showing the magnetic excitation part of the rotating electric machine apparatus shown in FIG. 16;

FIG. 20 is a plan view showing the magnetic excitation part of the rotating electric machine apparatus shown in FIG. 16;

FIG. 21 is a perspective view showing a displacement control means of the rotating electric machine apparatus shown in FIG. 16;

FIG. 22 is a longitudinal sectional view of a rotating electric machine apparatus according to a sixth embodiment of the present invention;

FIGS. 23(a) and 23(b) are plan views showing an armature and salient poles of the rotating electric machine apparatus shown in FIG. 22;

FIGS. 24(a) and 24(b) are plan views showing a magnetic excitation part of the rotating electric machine apparatus shown in FIG. 22;

FIGS. 25(a) and 25(b) are plan views showing a main magnetic pole, a bypass magnetic pole and a field magnet that are rotationally displaced in the rotating electric machine apparatus shown in FIG. 22; and

FIG. 26 is a block diagram of a rotating electric machine system for performing field-weakening control according to a seventh embodiment of the present invention.

### DETAILED DESCRIPTION OF THE PREFERRED EMBODIMENTS

Embodiments of the present invention will be described hereinafter with reference to the accompanying drawings. In the following description, the constituent elements having substantially the same function and arrangement are denoted by the same reference numerals, and repetitive descriptions will be made only when necessary.

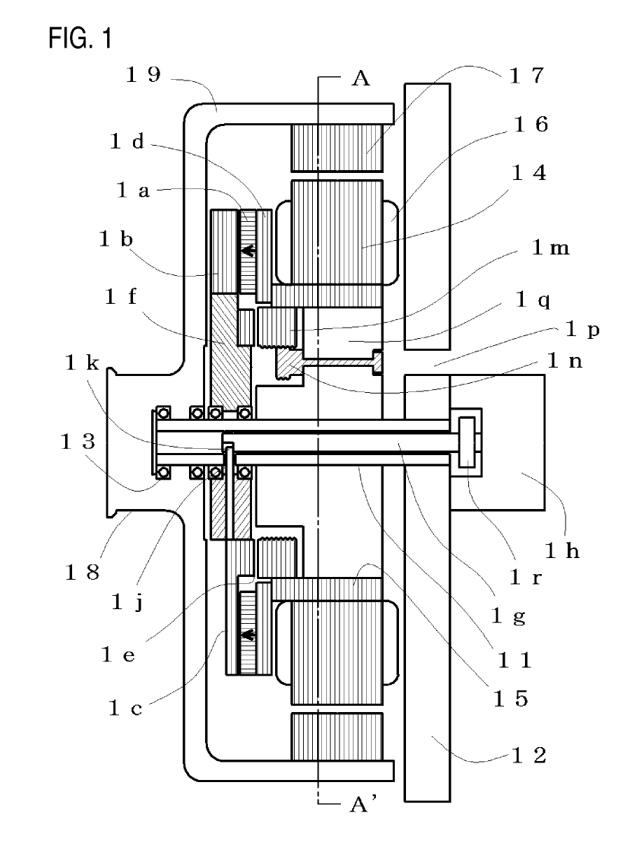

The rotating electric machine system according to a first embodiment of the present invention will be explained by using FIGS. 1 to 7. The first embodiment is a rotating electric machine system having a unipolar rotor with a radial gap structure and an outer rotor structure. The magnetic excitation part is disposed in a static side contiguous to the armature in the axial direction, and the magnetic flux flowing through the armature is controlled intermittently.

FIG. 1 illustrates the rotating electric machine apparatus with an outer rotor structure, and the magnetic salient poles are disposed in the rotor, and the armature is disposed on a fixed shaft 11. The fixed shaft 11 is fixed to a substrate 12, the armature is fixed to the fixed shaft 11, magnetic salient poles 17 are disposed in an iron rotor housing 19 made of a magnetic material that is supported rotatably through bearings 13 by the fixed shaft 11.

The armature includes, a cylindrical magnetic yoke 15 fixed to the fixed shaft 11, a plurality of magnetic teeth 14 extending in the radial directions from the cylindrical magnetic yoke 15, and armature coils 16 wound around the magnetic teeth 14.

The rotor housing 19 of the rotor has a pulley portion 18 for transmitting a rotational force between the rotor and outer equipment, the magnetic salient poles 17 and the non-magnetic portions are disposed one after the other in the circumferential direction, oppositely to the magnetic teeth 14.

The magnetic excitation part for magnetically exciting the magnetic salient poles 17 is disposed around the fixed shaft 11 and is disposed along with the armature, and the main part thereof includes a field magnet 1a, a main magnetic pole 1b, a bypass magnetic pole 1c, and a base magnetic pole 1d. And, the main magnetic pole 1b and the bypass magnetic pole 1c are supported by a magnetic excitation part support 1f, and the magnetic excitation part support 1f is rotatably supported by the fixed shaft 11. The number 1e represents the air gap between an extending portion of the bypass magnetic pole 1c and a movable base magnetic pole 1m. A gap length adjusting means of the air gap 1e includes the movable base magnetic pole 1m, an adjusting screw 1n prepared in an armature support 1q, and an access hole 1p.

The fixed shaft 11 has a hollow structure and has a control rod 1g to be able to slide in the hollow, and the control rod 1g is composed so as to be driven in the circumferential direction. The fixed shaft 11 has a slit portion 1j passing through the hollow, and is composed so that a pin 1k fixed to the magnetic excitation part support 1f through the slit portion 1j engages with the control rod 1g. Therefore, the magnetic excitation part support 1f, the main magnetic pole 1b, and the bypass magnetic pole 1c are rotationally displaced by rotational displacement of the control rod 1g. The number 1r represents a torque sensor.

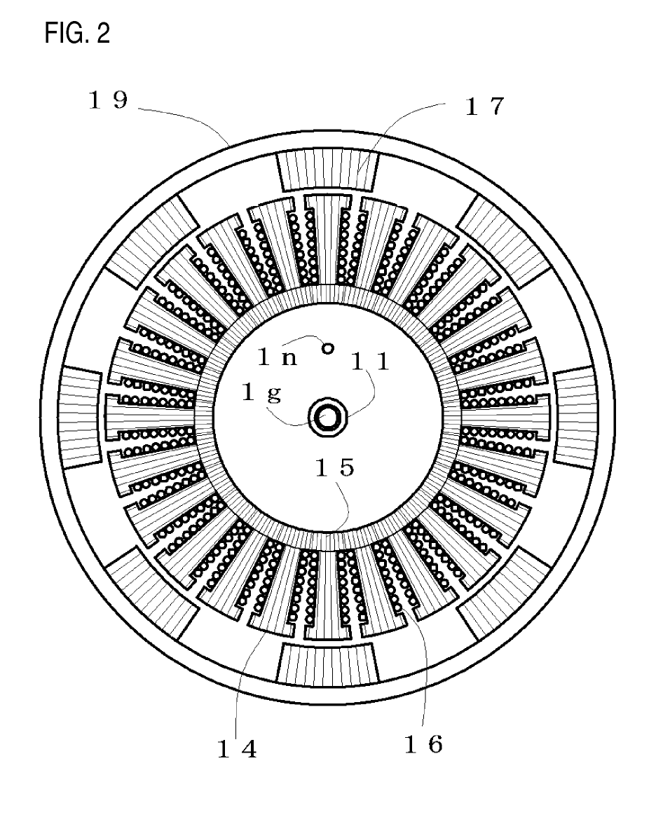

FIG. 2 shows a sectional view of the armature and the rotor along A-A′ of FIG. 1, and some of the component parts are appended with numbers for explaining the reciprocal relation. The armature is composed of the cylindrical magnetic yoke 15 fixed to the fixed shaft 11, a plurality of the magnetic teeth 14 having non-magnetic portions in the circumferential direction, and the armature coils 16 wound around the magnetic teeth 14. In the first embodiment, twenty four armature coils 16 are included and connected so as to have three phases. The magnetic teeth 14 and the cylindrical magnetic yokes 15 are composed by punching out a silicon steel plate by a predetermined die and then stacking the punched plates, and the armature coils 16 are wound.

In FIG. 2, in the rotor, eight magnetic salient poles 17 each in which silicon steel plates are stacked are disposed at even intervals in the circumferential direction. Spaces between the magnetic salient poles 17 are non-magnetic portions and composed as mere air gaps, but when windage loss works against the energy efficiency or acoustic noise generates at high-speed rotation, non-magnetic resin or the like having large specific resistance can be disposed in the air gap.

The field magnet is not disposed in the rotor, but by the magnetic excitation part, each of the magnetic salient poles 17 is magnetically connected to an end of the field magnet 1a and each of the magnetic teeth 14 is magnetically connected to the other end, and then the magnetic salient poles 17 are magnetized to be same magnetic direction. This is a unipolar rotating electric machine and has a difficult point of being used as an electric motor or as an electric generator, but has a merit that the structure is simple.

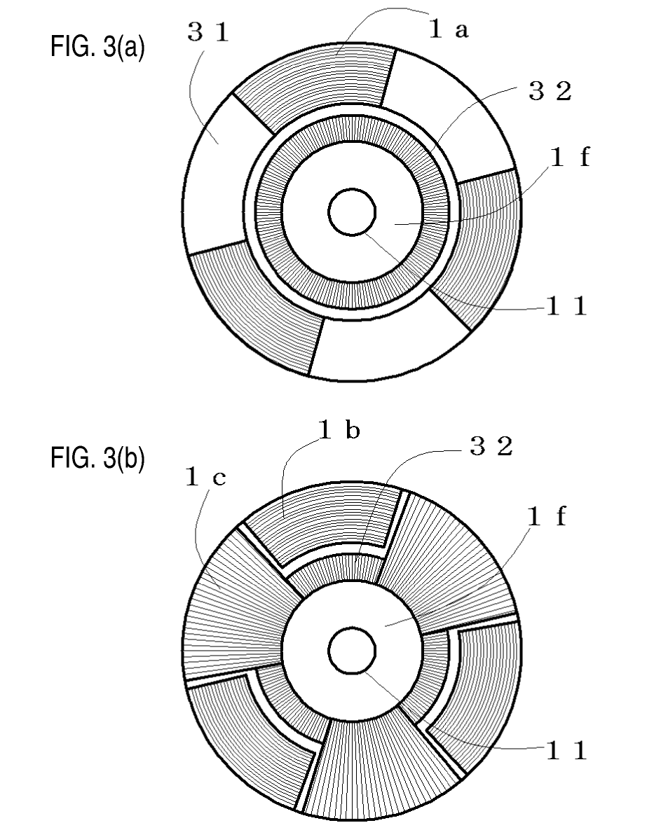

FIGS. 3(a) and 3(b) are plan views for explaining a structure of the magnetic excitation part as shown in FIG. 1 and the operating principle for controlling magnetic flux. FIG. 3(a) is a plan view including the field magnet 1a viewed from the side of the main magnetic pole 1b and the bypass magnetic pole 1c, and the FIG. 3(b) is a plan view including the main magnetic pole 1b and the bypass magnetic pole 1c viewed from the side of the rotor housing 19.

In FIG. 1 and FIG. 3(a), three field magnets 1a are disposed in the circumferential direction with sandwiching the non-magnetic portions 31. The magnetization direction of each of the field magnets 1a is the axial direction as represented by the arrows in FIG. 1, and two ends of the field magnet 1a are made to serve as a first magnet end and a second magnet end, the second magnet end is connected to the cylindrical magnetic yoke 15 through the base magnetic pole 1d, and the first magnet end is magnetically connected to the rotor housing 19 through the main magnetic pole 1b.

As shown in FIG. 1 and FIG. 3(b), each of the main magnetic poles 1b and each of the bypass magnetic poles 1c are rotatably disposed side by side, through micro gap and oppositely to the first magnet end of the field magnet 1a. In FIGS. 3(a) and (b), the cylindrical magnetic core represented by the number “32” is connected to the bypass magnetic pole 1c and rotatably displaced together, and connected to the base magnetic pole 1d through the air gap 1e, the movable base magnetic pole 1m, the cylindrical magnetic yoke 15. The movable base magnetic pole 1m is slid along the cylindrical magnetic yoke 15 by rotating the adjusting screw 1n.

The magnetic flux flowing from the first magnet end of the field magnet 1a to the main magnetic pole 1b forms a main magnetic flux pathway circulating to the second magnet end through the rotor housing 19, the magnetic salient poles 17, the magnetic teeth 14, the cylindrical magnetic yoke 15, and the base magnetic pole 1d. The magnetic flux flowing into the bypass magnetic pole 1c forms a bypass magnetic flux pathway circulating to the second magnet end through the cylindrical magnetic core 32, the air gap 1e, the movable base magnetic pole 1m, the cylindrical magnetic yoke 15, and the base magnetic pole 1d. By adjusting an opposed area and gap length of the air gap 1e between the cylindrical magnetic core 32 and the movable base magnetic pole 1m, the magnetic resistance of the main magnetic flux pathway and the magnetic resistance of the bypass magnetic flux pathway are set to be approximately equal. At this time, the magnetic resistance of the main magnetic flux pathway fluctuates according to relative position between the magnetic salient poles 17 and the magnetic teeth 14, and therefore, the averaged magnetic resistance thereof is set to be approximately equal to the magnetic resistance of the bypass magnetic flux pathway.

Alternating magnetic flux does not flow through the main magnetic pole 1b, the bypass magnetic pole 1c, the cylindrical magnetic core 32, the movable base magnetic pole 1m, and the base magnetic pole 1d as a general rule, and therefore, they are composed of magnetic material that mainly has iron, which has a large saturation magnetic flux density, and the entirety thereof is compactly composed. In order that the magnetic resistance between the field magnet 1a and (the main magnetic pole 1b and the bypass magnetic pole 1c) is composed to be small, the field magnet 1a and (the main magnetic pole 1b and the bypass magnetic pole 1c) are composed to be opposed through micro air gap or slid to each other.

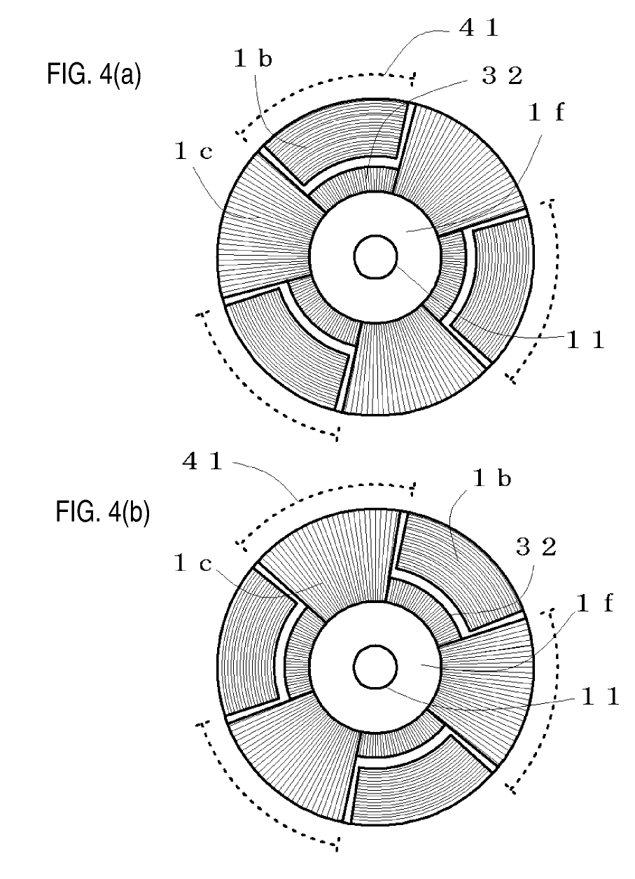

FIGS. 4(a) and 4(b) are plan views showing the main magnetic pole 1b and the bypass magnetic pole 1c viewed from the side of the rotor housing 19, similarly to FIG. 3(b). The respective figures show the cases in which the displacement in the circumferential direction between (the main magnetic pole 1b and the bypass magnetic pole 1c) and the field magnet 1a is minimum and maximum, respectively. That is, they show the cases in which the magnetic flux amount between the magnetic salient poles 17 and the magnetic teeth 14 are set to be maximum and minimum, respectively.

In the figures, the number 41 shows the existence regions of the field magnets 1a in the circumferential direction, and as shown in FIG. 4(a), in the state at the standard position, the field magnets 1a are opposed to the entire region of the main magnetic pole 1b and opposed slightly to the bypass magnetic pole 1c. In this case, the approximately entire amount of the magnetic flux from the field magnets 1a flows through the main magnetic poles 1b, between the magnetic salient poles 17 and the magnetic teeth 14.

FIG. 4(b) shows the case in which the main magnetic pole 1b and the bypass magnetic pole 1c are rotationally displaced clockwise at the degree equal to the angle length in the circumferential direction of the main magnetic pole 1b, and in this state, the field magnet 1a is opposed to the entire region of the bypass magnetic pole 1c and opposed slightly to the main magnetic pole 1b. In this case, the approximately entire amount of the magnetic flux from the field magnets 1a circulates to the second magnet end through the bypass magnetic pole 1c and through the cylindrical magnetic core 32, the air gap 1e, the movable base magnetic pole 1m, the cylindrical magnetic yoke 15, and the base magnetic pole 1d.

In the intermediate state between the cases shown in FIGS. 4(a) and 4(b), the field magnet 1a is opposed to both of the main magnetic pole 1b and the bypass magnetic pole 1c, and magnetic flux from the field magnet 1a is divided to flow into the main magnetic flux pathway and the bypass magnetic flux pathway. The important point is that the main magnetic pole 1b and the bypass magnetic pole 1c are opposed through micro gap to the field magnet 1a themselves, which are sources of the magnetic flux. And, the magnetic flux is divided to flow, proportionally to the respective opposed areas of the main magnetic pole 1b and the bypass magnetic pole 1c. Furthermore, in this structure, the sum of the respective opposed areas of the main magnetic pole 1b and the bypass magnetic pole 1c is constant, and therefore, the ratio of the areas is changed according to the displacement. Magnetic resistances of the main magnetic flux pathway and the bypass magnetic flux pathway are set to be equal and the total of the magnetic flux amount from the field magnets 1a is always constant, and therefore, a magnetic force preventing the rotational displacement of the main magnetic pole 1b and the bypass magnetic pole 1c does not appear.

In the case in which the field magnet 1a is opposed to the main magnetic pole 1b and the bypass magnetic pole 1c through magnetic material, the field magnet 1a comes to be connected to a magnetic circuit composed of magnetic resistance of the air gap portion between the intervenient magnetic material and (the main magnetic pole 1b and the bypass magnetic pole 1c), magnetic resistance of the main magnetic flux pathway and the bypass magnetic flux pathway, and so forth. The magnetic resistance in this magnetic circuit is changed along with rotational displacement of the main magnetic pole 1b and the bypass magnetic pole 1c, and therefore, the total amount of the magnetic flux from the field magnets 1a is changed and leads to appearance of the magnetic force preventing the main magnetic pole 1b and the bypass magnetic pole 1c from being rotationally displaced.

Furthermore, it is difficult to constitute the magnetic resistance of the main magnetic flux pathway and the bypass magnetic flux pathway equally strictly. When a difference is in both magnetic resistance, and the field magnet 1a opposes to the main magnetic pole 1b and the bypass magnetic pole 1c through a magnetic material, the magnetic flux from the field magnet 1a is divided in the above-mentioned magnetic material. Therefore the magnetic flux amount flowing through the main magnetic flux pathway does not become proportional to the opposite area between the field magnet 1a and the main magnetic pole 1b and becomes difficult for the field strength control.

When the field magnet 1a is opposed to the main magnetic pole 1b and the bypass magnetic pole 1c through magnetic material because of the structural reason, magnetic material having strong anisotropy or magnetic material having thin thickness should be used as the magnetic material to prevent the magnetic flux from being divided to flow within the magnetic material. This structure is included in the theme of the present invention in the point that the magnetic flux is substantially divided to flow at an end face of the field magnet 1a.

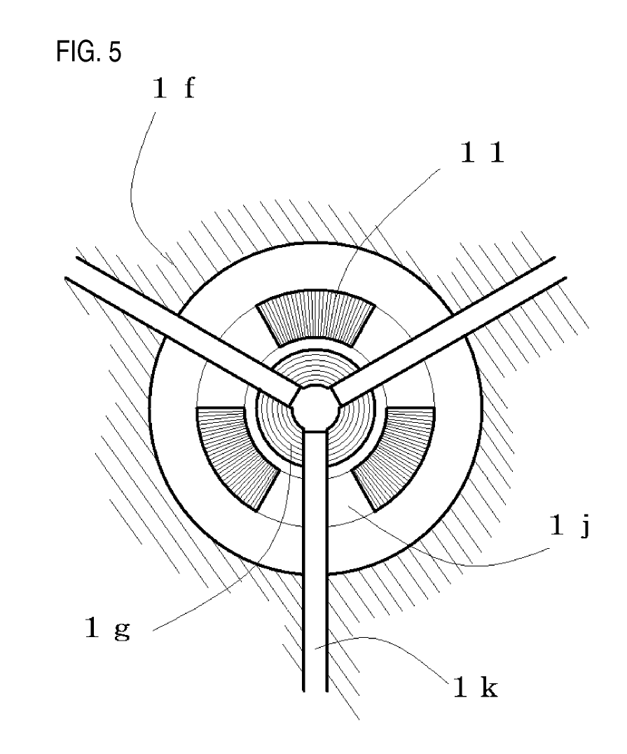

It has been explained that by rotationally displacing the main magnetic pole 1b and the bypass magnetic pole 1c, the magnetic flux flowing between the magnetic salient poles 17 and the magnetic teeth 14 can be controlled at almost 100% and the magnetic force preventing the rotational displacement is not theoretically caused. Hereinafter, by using FIGS. 1 and 5, the structure in which the main magnetic pole 1b and the bypass magnetic pole 1c are rotationally displaced will be explained.

FIG. 5 is a magnified sectional view showing a part in which the pin 1k fixed to the magnetic excitation part support 1f engages with the control rod 1g. In this structure, there are three pins 1k, and the fixed shaft 11 is provided with the slit portion 1j, and three groove portions corresponding to the pins 1k at the end face of the control rod 1g. The fixed shaft 11 is inserted into the magnetic excitation part support 1f, and then, the pins 1k are punched in from the periphery of the magnetic excitation part support 1f, and the pins 1k are fixed so as to stick out to the hollow in the fixed shaft 11. The control rod 1g is inserted into the hollow of the fixed shaft 11 and the pins 1k are made to engage with the groove portions at the end face of the control rod 1g.

The actuator 1h rotationally displaces the control rod 1g according to order from a control device, and rotationally displaces the magnetic excitation part support 1f. In this case, position in the circumferential direction and angle length in the circumferential direction of each of the slit portions 1j are set as displacement regulating means for binding the main magnetic pole 1b and the bypass magnetic pole 1c into the displacement in the range shown in FIGS. 4(a) and (b).

The actuator 1h is composed to maintain the rotational position by using a step motor, but can also be composed to be capable of maintaining the rotational position by additionally combining a motor, a screw mechanism, a gear mechanism, or the like.

Although magnetic resistance of the main magnetic flux pathway and the bypass magnetic flux pathway is adjusted equally, when current is flowing into the armature coil, the magnetic resistance of the main magnetic flux pathway changes in an appearance. In case that the electric motor is driven in accelerating manner, the magnetic flux is pulled in the magnetic teeth, and then the amount of the magnetic flux in it became larger. In the inverse case, the magnetic flux is purged from the magnetic teeth, and then the amount of the magnetic flux in it became smaller. Therefore the magnetic resistance of the main magnetic flux pathway is viewed to be effectively smaller when the rotor is accelerated and larger when the rotor is decelerated.

In this embodiment, magnetic field control is intermittently performed during operation of the rotating electric machine system as follows. The current of predetermined conditions is supplied to the armature coils to accelerate or to decelerate the rotor so that magnetic resistance of the main magnetic flux pathway and the bypass magnetic flux pathway become effectively equal, and simultaneously the actuator 1h is driven. This embodiment also has the composition to acquire the above predetermined conditions in learning way during operation of the rotating electric machine system, and becomes possible to adapt magnetic resistance change of the main magnetic flux pathway by various causes.

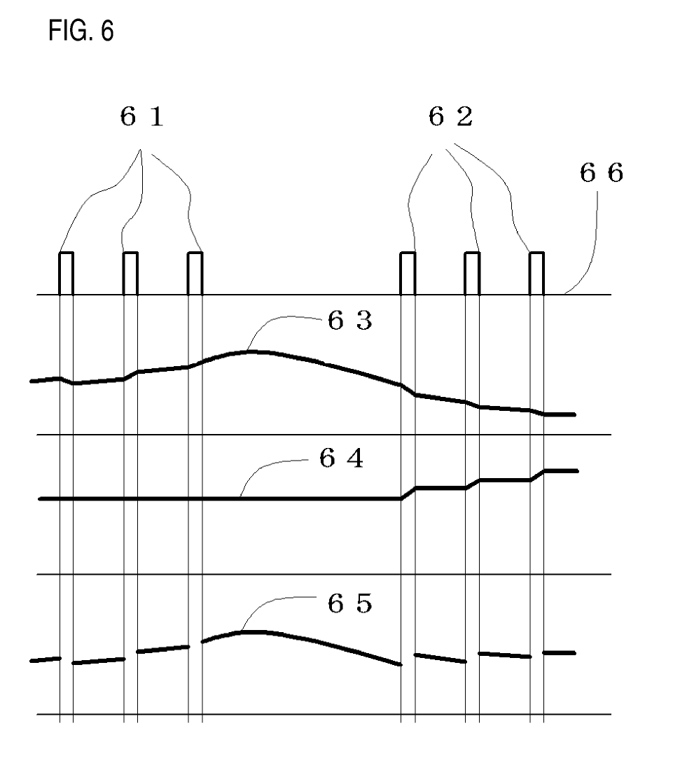

The composition and the procedure which acquire the predetermined current condition to adjust magnetic resistance of the main magnetic flux pathway effectively in learning way are explained using FIGS. 1 and 6. The number 1r represents the torque sensor. Although torque sensors based on various principles exist, but a strain gauge is small and suitable for the torque sensor 1r.

When an electric current is supplied in armature coil 16 to accelerate or to decelerate the rotor, magnetic resistance of the main magnetic flux pathway seems to be smaller or larger respectively. If a difference is in the magnetic resistance of the main magnetic flux pathway and the bypass magnetic flux pathway, the combination of the main magnetic pole 1b and the bypass magnetic pole 1c will receive the magnetic force to displace in the direction which increases the opposite area between the field magnet 1a and the magnetic pole of the magnetic flux pathway with smaller magnetic resistance. The actuator 1h maintains the circumferential direction location, so the control rod 1g will be twisted, and it is possible to detect the above-mentioned magnetic force by the torque sensor 1r.

FIG. 6 shows the time chart which controls the magnetic flux intermittently, and the horizontal axis 66 represents time. The number 61 represents a learning section, and the number 62 represents a field control section. During time except the learning section 61 and the field control section 62, the rotor is driven or generated power is taken out.

In the learning section 61, the control device drives the rotor by different current conditions and watches the torque sensor 1r output in the period. The current conditions from which the torque sensor 1r output becomes small are conditions which make effectively equal the magnetic resistances of the main magnetic flux pathway and the bypass magnetic flux pathway, and the control device memorizes them or set them again as the predetermined current conditions.

The number 62 represents the field control section. The current is supplied to the armature coil 16 on the conditions acquired by the learning process, the actuator 1h is controlled simultaneously, and the combination of the main magnetic pole 1b and the bypass magnetic pole 1c is made to displace in the direction of a circumference. Because magnetic resistance of the main magnetic flux pathway and the bypass magnetic flux pathway are made effectively almost equal, the control by the actuator 1h is performed smoothly. In this case, the rotor is driven even for a short time, then the rotating speed 63 changes. The rotor is decelerated during the field control section 62, it is little, but the decelerated state is indicated by the rotating speed 63.

The number 64 represents the magnetic flux amount in the armature, and the actuator 1h maintains the circumferential position, so the magnetic flux amount 64 does not change during the learning section 61, but the state from which the magnetic flux amount 64 changes is indicated at the field control section 62.

The number 65 represents power generation voltage in the case when rotating electric machine apparatus is a generator. In the learning section 61 and the field control section 62, since electric power cannot be taken out, the state where the power generation voltage 65 has broken off is shown, and the state where the power generation voltage 65 is changing is shown by the around field control sections 62.

In this embodiment, each rotating electric machine is being adjusted after assembly so that magnetic resistance of the bypass magnetic flux pathway may become equal to magnetic resistance of the main magnetic flux pathway. Therefore the degree that the rotor is driven by the above-mentioned field control process is small.

Although the predetermined current conditions for adjusting the magnetic resistance of the main magnetic flux pathway effectually were acquired during the learning section 61 in this embodiment, the method of not setting up the learning section 61 in particular is also possible. For example, when the rotating electric machine apparatus is an electric motor, the relationship between the current supplied to the armature coils and the torque sensor 1r output is always supervised, and the current conditions from which the torque sensor 1r output becomes smallest is made into the predetermined current conditions.

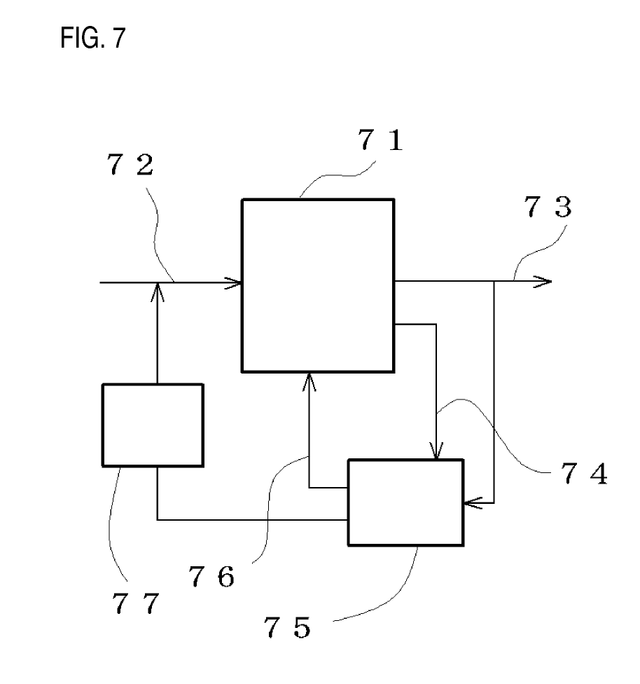

As described above, in the rotating electric machine apparatus shown in FIGS. 1 to 6, it has been explained that by relatively displacing the main magnetic pole 1b and the bypass magnetic pole 1c with respect to the field magnet 1a, the magnetic flux amount between the magnetic salient poles 17 and the magnetic teeth 14 can be controlled at almost 100%, and furthermore, the means and the method for displacing the main magnetic pole 1b and the bypass magnetic pole 1c with respect to the field magnet 1a have been explained. The first embodiment is a system for optimizing the output by controlling the magnetic flux amount, and the control method as the rotating electric machine system will be explained by using FIG. 7.

FIG. 7 shows a block diagram of the rotating electric machine system for controlling the field strength. In FIG. 7, the rotating electric machine apparatus 71 has an input 72 and an output 73, and a control device 75 controls the field strength of the rotating electric machine apparatus 71 through a control signal 76 referring to an output 73 of the rotating electric machine apparatus 71 and a state signal 74 including positions of the main magnetic pole 1b and the bypass magnetic pole 1c that are in the movable magnetic pole part. The number 77 represents a driving circuitry of the armature coils 16. If the rotating electric machine apparatus 71 is used as an electric generator, the input 72 is a rotational force and the output 73 is the electric power. If the rotating electric machine apparatus 71 is used as an electric motor, the input 72 is a driving current supplied to the armature coils 16 from the driving circuitry 77 and the output 73 is a rotational torque or a rotational speed.

A rotating electric machine system in which the rotating electric machine apparatus serves as an electric motor and by which the field-weakening control is performed to optimize the rotational force control will be explained.

When the rotational speed that is the output 73 becomes larger than a predetermined value and the magnetic flux amount between the magnetic salient poles 17 and the magnetic teeth 14 is made to be smaller, the control device 75 supplies the predetermined current to the armature coil 16 through the driving circuitry 77 in the time zone of the field control section 62 so that magnetic resistances of the main magnetic flux pathway and the bypass magnetic flux pathway are effectively made equal, and simultaneously drives the main magnetic pole 1b and the bypass magnetic pole 1c clockwise in FIGS. 3(a), 3(b), 4(a), and 4(b) through the actuator 1h and the control rod 1g by the control signal 76, and thereby, the opposed area between the main magnetic pole 1b and the field magnet 1a is made to be smaller.

When the rotational speed becomes smaller than a predetermined value and the magnetic flux amount between the magnetic salient poles 17 and the magnetic teeth 14 is made to be larger, the control device 75 supplies the predetermined current to the armature coil 16 through the driving circuitry 77 in the time zone of the field control section 62, and simultaneously drives the main magnetic pole 1b and the bypass magnetic pole 1c counterclockwise through the actuator 1h and the control rod 1g, and thereby, the opposed area between the main magnetic pole 1b and the field magnet 1a is made to be larger.

A constant-voltage power generation system in which the rotating electric machine apparatus serves as an electric generator and by which the field-weakening control is performed to control the power generation voltage to be a predetermined voltage will be explained.

When the power generation voltage that is the output 73 becomes larger than a predetermined value and the magnetic flux amount between the magnetic salient poles 17 and the magnetic teeth 14 is made to be smaller, the control device 75 supplies the predetermined current to the armature coil 16 through the driving circuitry 77 in the time zone of the field control section 62, and simultaneously drives the main magnetic pole 1b and the bypass magnetic pole 1c clockwise in FIGS. 3(a), 3(b), 4(a), and 4(b) through the actuator 1h and the control rod 1g by the control signal 76, and thereby, the opposed area between the main magnetic pole 1b and the field magnet 1a is made to be smaller.

When the power generation voltage becomes smaller than a predetermined value and the magnetic flux amount between the magnetic salient poles 17 and the magnetic teeth 14 is made to be larger, the control device 75 supplies the predetermined current to the armature coil 16 through the driving circuitry 77 in the time zone of the field control section 62, and simultaneously drives the main magnetic pole 1b and the bypass magnetic pole 1c counterclockwise through the actuator 1h and the control rod 1g, and thereby, the opposed area between the main magnetic pole 1b and the field magnet 1a is made to be larger.

Generally, the magnetic resistance of the main magnetic flux pathway is not always constant, it fluctuates according to the relative positions between the magnetic salient poles and the magnetic teeth. The magnetic resistance of the main magnetic flux pathway is equalized by reflection of the various relative positions between the magnetic salient poles and the magnetic teeth in the entire circumference, and also the displacement control of the main magnetic pole 1b and the bypass magnetic pole 1c is slower than the rotational speed. Therefore the fluctuation of the magnetic resistance of the main magnetic flux pathway does not become an obstacle to the displacement control. However, the structure in which the side surfaces in the circumferential direction of the parts such as the magnetic teeth 14 and magnetic salient poles 17 are tapered, the structure in which widths in the circumferential direction of the parts are varied, or the like, has an advantage that the above-described fluctuation of the magnetic resistance is moderated. This is also desirable in the point that generation of vibration, sound, and so forth that can be generated during the rotation is suppressed.

Furthermore, in the present embodiment, the magnetic force is not generated when the main magnetic pole 1b and the bypass magnetic pole 1c are displaced, but a magnetic force except for the displacement direction is generated. If the main magnetic pole 1b and the bypass magnetic pole 1c are displaced, a magnetic force against the displacement in the circumferential direction does not appear, but the magnetic force between (the main magnetic pole 1b and the bypass magnetic pole 1c) and the field magnet 1a appears and changes according to the displacement. However, the force does not prevent the displacement because of the perpendicular relation to the displacement of the circumferential direction. The structural strength is set and treated under the assumption that the magnetic force between (the main magnetic pole 1b and the bypass magnetic pole 1c) and the field magnet 1a fluctuates.

The magnetic resistance of the bypass magnetic flux pathway is controlled by adjusting the opposed area and the length of the air gap 1e, but it is also possible that the magnetic resistance of the bypass magnetic flux pathway is controlled by arranging a permanent magnet in the bypass magnetic flux pathway or by winding a coil around the bypass magnetic flux pathway. The permanent magnet is fixed, but has a characteristic that the entirety can be compact. And the coil can control the magnetic resistance of the bypass magnetic flux pathway according to the use mode of the case such as the electric motor or the electric generator.

In the case of the electric motor, the interaction between the armature and the field magnet part during accelerating the rotor is a force attracting to each other, and the amount of the magnetic flux flowing the main magnetic flux pathway is enlarged. If this is viewed from the field magnet side, the magnetic resistance of the main magnetic flux pathway is viewed to be effectively smaller. To the contrary, the interaction between them during decelerating the rotor is a force repulsing to each other, and the magnetic resistance of the main magnetic flux pathway is viewed to be effectively larger. The present embodiment exploits these phenomena, and then can correct the magnetic resistance deviation of the main magnetic flux pathway caused by the tolerances of related parts dimension and the temperature change.

When the magnetic resistance of the main magnetic flux pathway can be dedicated in tolerance level from a design value, the magnetic resistance adjustment of the bypass magnetic flux pathway after the assembly of the rotating electric machine adopted in this embodiment can be made unnecessary. Moreover, when the magnetic resistance of the main magnetic flux pathway under operation does not shift from an initial state greatly, it is possible to omit the learning process adopted by this embodiment. The magnetic resistance compensation method of the main magnetic flux pathway in this embodiment can be partially adopted according to the specification or the operating condition of the rotating electric machine apparatus for the optimal system.

As explained using the present embodiment, according to this invention, connecting two magnetic flux pathways, the main magnetic flux pathway and the bypass magnetic flux pathway, to the field magnet in parallel, the magnetic flux from the field magnet is made to shunt, and division ratio of the magnetic flux from the field magnet is changed by relative displacement between the field magnet and the magnetic flux pathways. Magnetic flux pathways are always connected to the field magnet, so even if the magnetic flux amount in the main magnetic flux pathway is changed, there is no concern made to demagnetize the field magnet. Moreover, the total amount of the magnetic flux which flows from the field magnet by setting magnetic resistance of two of magnetic flux pathways as predetermined conditions is always made constant, and then magnetic force preventing the mechanical displacement can be maintained small. Thereby, the field control in the main magnetic flux pathway can be smoothly performed.

It is important to establish magnetic resistances of the main magnetic flux pathway and the bypass magnetic flux pathway equally mostly, and the magnetic power disturbing the displacement can be suppressed small and the field control can be carried out smoothly. The meaning that is “equally mostly” is to establish both magnetic resistances so that the magnetic power may be suppressed below the output of the actuator used for the displacement. This embodiment indicates a system that has the function to adjust the magnetic resistance of the main magnetic flux pathway effectively, it is not necessary to set up strictly the magnetic resistance of the main magnetic flux pathway and the bypass magnetic flux pathway equally. The meaning “equally mostly” can be supposed that both magnetic resistance is set as the range made equally by adjusting the magnetic resistance of the main magnetic flux pathway effectively in this embodiment. But the rotor is accelerated or is decelerated during the process to which magnetic resistance of the main magnetic flux pathway is adjusted equally effectively, therefore, in the case with the great difference in both magnetic resistances, and the accelerated or decelerated degree of the rotor may become big. As for both magnetic resistances, it is desirable to set up as equally as possible.

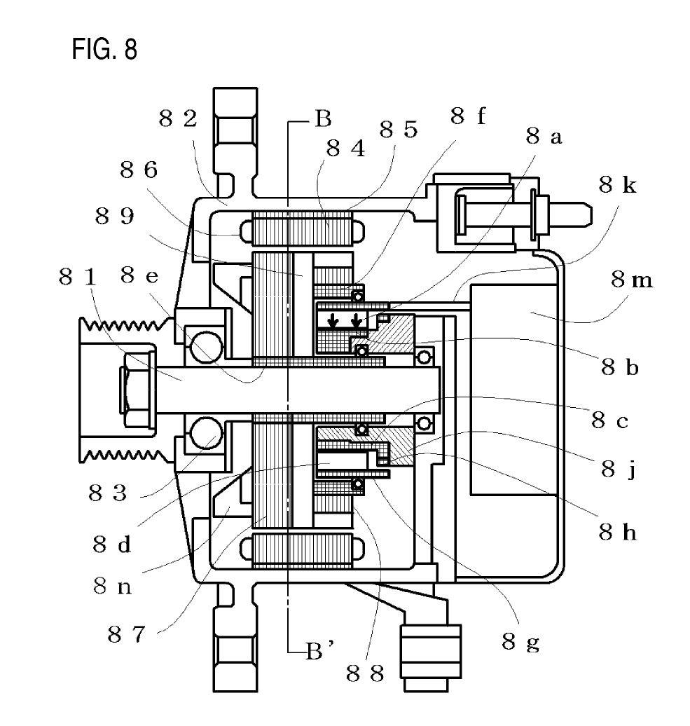

The rotating electric machine system according to a second embodiment of the present invention will be explained by using FIGS. 8 to 11. The second embodiment is a rotating electric machine system in which two rotors each having a simple structure the magnetic salient poles and the non-magnetic portions one after the other are disposed in parallel, and in which the magnetic excitation part is disposed at the housing side. Moreover, the second embodiment connects a predetermined constant current load to armature coils at the time of the field strength control, makes predetermined current flow in armature coils by induced voltage, and adjusts the magnetic resistance of the main magnetic flux pathway effectively.

FIG. 8 shows the rotating electric machine apparatus having a radial gap structure, the rotational shaft 81 is supported rotatably by a housing 82 through bearings 83. The armature includes a cylindrical magnetic yoke 85 fixed to the housing 82, a plurality of magnetic teeth 84 extending radially from the cylindrical magnetic yoke 85, and the armature coils 86 wound around the magnetic teeth 84.

Each of the rotors has a simple structure in which the magnetic salient poles and the non-magnetic portions are lined one after the other in the circumferential direction, and surface magnetic pole parts 87 and 88 of two rotors are disposed side by side in the axial direction. The number 89 represents a non-magnetic disc.

The magnetic excitation part magnetizing the magnetic salient poles in the surface magnetic pole parts 87, 88 of the two rotors to be different direction from each other is disposed at the housing side 82, and the main part thereof includes a field magnet 8a, a main magnetic pole 8b, and a bypass magnetic pole 8c. The main magnetic pole 8b and the bypass magnetic pole 8c are fixed to a magnetic excitation part support 8j, and the magnetic excitation part support 8j is fixed to the housing 82. The field magnet 8a is fixed to a field magnet support 8g. The field magnet 8a and the field magnet support 8g are supported so as to be possible to slide on the main magnetic pole 8b and the bypass magnetic pole 8c in the circumferential direction, and are connected to an actuator 8m through a control rod 8k. The number 8n represents a cooling fan fixed to the rotor.

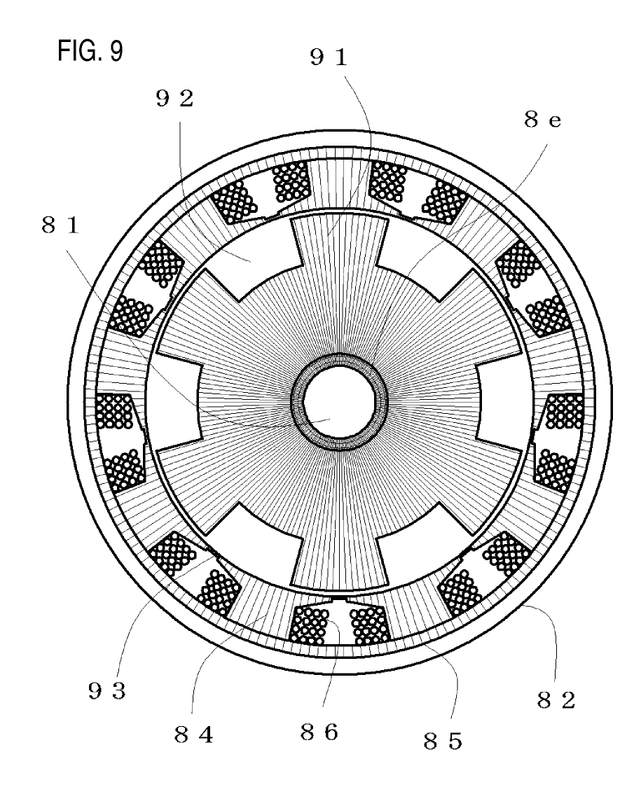

FIG. 9 shows a sectional view of the armature and the rotor along the B-B′ in FIG. 8, and some component parts are appended with numbers for explaining the mutual relations. The armature includes the cylindrical magnetic yoke 85 fixed to the housing 82, a plurality of magnetic teeth 84 extending radially from the cylindrical magnetic yoke 85 and having non-magnetic portions in the circumferential direction, and the armature coils 86 wound around the magnetic teeth 84. The second embodiment includes nine armature coils 86, and three phases thereof are connected. In the edges of the magnetic teeth 84 of the armature, saturable magnetic junctions 93 that are short in the radial direction are provided between the contiguous edges of the magnetic teeth 84. The magnetic teeth 84 and the saturable magnetic junctions 93 are punched out of a silicon steel plate by a predetermined die and stacked and wound with the armature coils 86, and then, combined with the cylindrical magnetic yoke 85, and thereby the armature is produced.

The saturable magnetic junctions 93 improve the support strength of the magnetic teeth 84 integrally with the magnetic teeth 84, and suppress unnecessary vibration of the magnetic teeth 84. The radial length of each of the saturable magnetic junctions 93 is set to be short, and thereby, the shape thereof that is easy to be magnetically saturated. Therefore, the junctions 93 are easy to be saturated with the magnetic flux generated by the armature coils 86 or the magnetic flux, and in such a case, the shorted amount of the magnetic flux generated by the armature coils 86 and the magnetic flux is made to be small. When a current is supplied to the armature coils 86, the saturable magnetic junctions 93 are magnetically saturated and then begin to leak the magnetic flux, along with time passing. The border of the effective non-magnetic portions appearing in the saturable magnetic junctions 93 that are magnetically saturated is not clear, and therefore, the distribution of the leaking magnetic flux becomes mild, and also in this point, the saturable magnetic junctions 93 contribute to the suppression of vibration with moderating time change of the force applied to the magnetic teeth 84.

In FIG. 9, the rotor has a structure having the magnetic salient poles 91 and the non-magnetic portions 92 one after the other in the circumferential direction and is composed by punching out a silicon steel plate by a predetermined die and stacking the punched-out plates. The surface magnetic pole parts 87, 88 of the two rotors have the same structures and are disposed so that the magnetic salient poles 91 of the surface magnetic pole part 87 and non-magnetic portions 92 of the surface magnetic pole part 88 correspond axially. The non-magnetic portions 92 between the magnetic salient poles 91 are composed simply as air gap. However, when windage loss works against the energy efficiency or acoustic noise generates at high-speed rotation, non-magnetic resin or the like having large specific resistance can be disposed in the air gap.

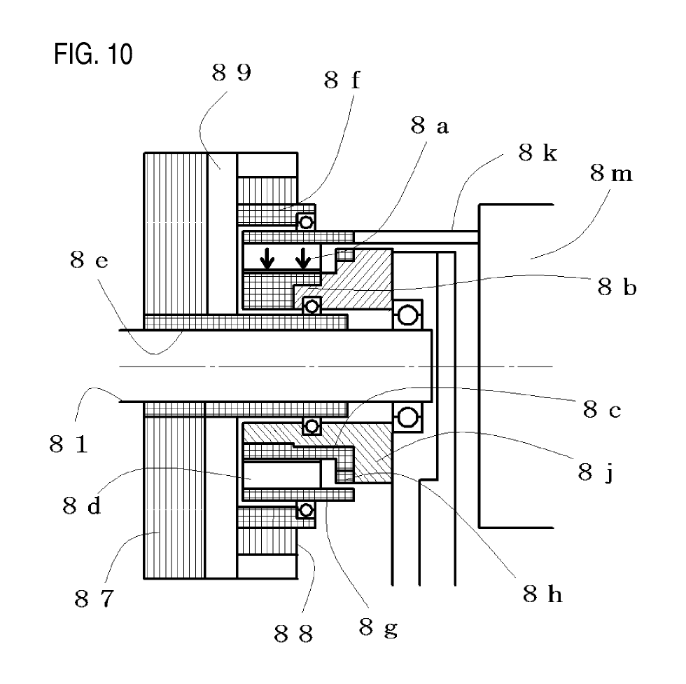

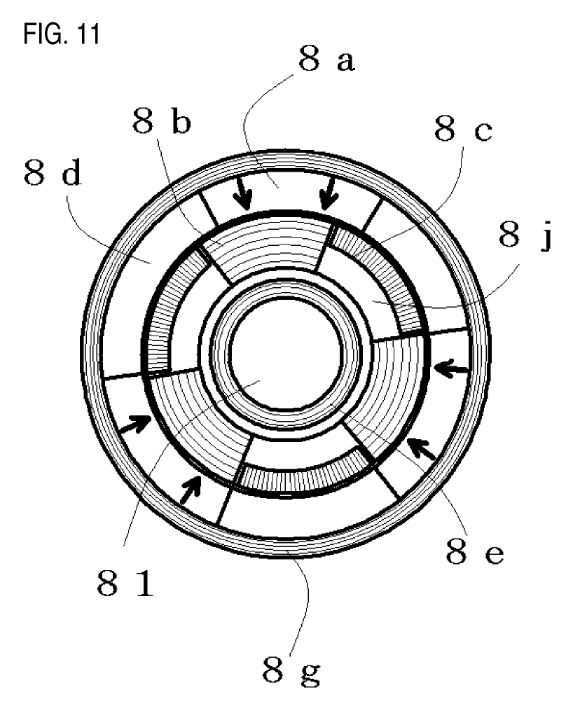

FIG. 10 shows magnified longitudinal sectional view of the rotor and the magnetic excitation part shown in FIG. 8, and FIG. 11 shows the sectional view of the magnetic excitation part. The constitution of the magnetic excitation part and operating principle of the field control are explained using FIGS. 8, 10, and 11.

The main part of the magnetic excitation part includes the field magnet 8a, the main magnetic pole 8b, and the bypass magnetic pole 8c. There are three of the field magnets 8a with magnetization of radial direction, and the field magnets 8a and the non-magnetic portions 8d are disposed one after the other in the circumferential direction, and are fixed to the inner circumference side of a field magnet support 8g. The pair of the main magnetic pole 8b and the bypass magnetic pole 8c are disposed to face each of the field magnets 8a, is arranged and fixed to the magnetic excitation part support 8j. The bypass magnetic pole 8c is further connected to a circular magnetic core 8h, and the circular magnetic core 8h is disposed to face the field magnet support 8g through a gap.

A cylindrical magnetic core 8e fixed on the rotational shaft 81 connects with the surface magnetic pole part 87, and the cylindrical magnetic core 8e faces the main magnetic pole 8b through a minute gap. A cylindrical magnetic core 8f fixed to the surface magnetic pole part 88 faces the field magnet support 8g through a minute gap. Since alternating magnetic flux does not flow into the main magnetic pole 8b, the bypass magnetic pole 8c, the field magnet support 8g, the circular magnetic core 8h, the cylindrical magnetic cores 8e and 8f, they constitute from iron with large saturation magnetic flux density, and the magnetic excitation part is constituted compactly.

The magnetic excitation parts in the present embodiment and the first embodiment are similar in their composition. Different points are the magnetization direction of the field magnet 8a, and the direction that the field magnet 8a faces the main magnetic pole 8b and the bypass magnetic pole 8c. This embodiment has the constitution that the field magnet 8a is able to slide on the main magnetic pole 8b and the bypass magnetic pole 8c in the circumferential direction, and the field magnet 8a is displaced by the actuator 8m. The actuator 8m connects with the field magnet 8a and the field magnet support 8g by three control rod 8k through the windows prepared in the housing 82, and makes them to displace in circumferential direction so as to change opposing area between the field magnet 8a and the main magnetic pole 8b.

A main magnetic flux pathway and a bypass magnetic flux pathway are connected to the field magnet 8a in parallel. The main magnetic flux pathway is the flux pathway in which a magnetic flux circulates through the main magnetic pole 8b, the cylindrical core 8e, the magnetic salient pole 91 of the surface magnetic pole part 87, the magnetic teeth 84, the magnetic salient pole 91 of the surface magnetic pole part 88, the cylindrical core 8f, and the field magnet support 8g. The bypass magnetic flux pathway is the flux pathway in which a magnetic flux circulates through the bypass magnetic pole 8c, the circular magnetic core 8h, and the field magnet support 8g. Magnetic flux is shunted in the main magnetic flux pathway and the bypass magnetic flux pathway according to the field magnet 8a displacement in a circumferential direction, and magnetic flux amount flowing in the main magnetic flux pathway is controlled.

In this embodiment of the invention, the most important point is setting up almost equally the magnetic resistance of the main magnetic flux pathway and the magnetic resistance of the bypass magnetic flux pathway so that the magnetic force disturbing the field magnet 8a displacement is maintained to be small. In this embodiment, length and opposing area of the non-magnetic gap area between the circular magnetic core 8h and the field magnet support 8g are adjusted so that the magnetic resistance of the bypass magnetic flux pathway becomes almost equal to the magnetic resistance of the main magnetic flux pathway.

In the present embodiment, a stepping motor is used as the actuator 8m, and the field magnet 8a is displaced through the control rod 8k. When the stepping motor is not driven, the axial position of the field magnet 8a is maintained, and entire energy consumption for the magnetic field control is small.

The present embodiment does not have the movable base magnetic pole 1m, the adjusting screw 1n for adjusting the magnetic resistance of the bypass magnetic flux pathway as adopted in the first embodiment. When the field strength between the magnetic salient poles 91 and the magnetic teeth 84 is to be changed, the present embodiment connects the predetermined constant current loads(not shown in Figures) to the armature coils 86 for effectively adjusting the magnetic resistance of the main magnetic flux pathway.

When a rotating electric machine apparatus is used as a dynamo, if predetermined impedance load is connected to the armature coils 86, voltage is induced by interlinked magnetic flux with armature coils 86 and current of the direction which reduces the interlinked magnetic flux flows according to the impedance of load. Thereby, the magnetic resistance of the main magnetic flux pathway becomes larger effectively. After assembling the rotating electric machine, each constant current load that enables the magnetic resistance of the main magnetic flux pathway to be effectively equal to the magnetic resistance of the bypass magnetic flux pathway is surveyed and memorized in a control device. When the field strength between the magnetic salient poles 91 and the magnetic teeth 84 is to be changed, the predetermined constant current load is connected to armature coils 86 for effectively equalizing the magnetic resistance of the main magnetic flux pathway to the one of the bypass magnetic flux pathway and then the magnetic force preventing the displacement of the field magnet 8a becomes small.

There are various methods in the means to realize the constant current load, and there is load which has a constant current circuit controlled so that predetermined current flows through the armature coils with the induction voltage, or the predetermined impedance defined for every rotational speed. The constant current circuit (not shown in the figures) is used in this embodiment.

As described above, in the rotating electric machine apparatus shown in FIGS. 8 to 11, it has been explained that by relatively displacing the field magnet 8a with respect to the main magnetic pole 8b and the bypass magnetic pole 8c, the magnetic flux amount between the magnetic salient poles 91 and the magnetic teeth 84 can be controlled at almost 100%, and furthermore, the means and the method for displacing the field magnet 8a with respect to the main magnetic pole 8b and the bypass magnetic pole 8c have been explained. The second embodiment is a system for optimizing the output by controlling the magnetic flux amount, and the control method as the rotating electric machine system will be explained by using FIG. 7.

A rotating electric machine system in which the rotating electric machine apparatus serves as an electric motor and by which the field-weakening control is performed to octimize the rotational force control will be explained.

When the rotational speed that is the output 73 becomes larger than a predetermined value and the magnetic flux amount between the magnetic salient poles 91 and the magnetic teeth 84 is made to be smaller, the control device 75 connects the predetermined constant current circuit which sends predetermined current to the armature coils 86 by the induced voltage so that magnetic resistance of the main magnetic flux pathway and magnetic resistance of the bypass magnetic flux pathway become effectively equal, and makes the actuator 8m drive the control rod 8k in the direction of a clockwise rotation in FIG. 11 by the control signal 76, and thereby, the opposed area between the main magnetic pole 8b and the field magnet 8a is made to be smaller.

When the rotational speed becomes smaller than a predetermined value and the magnetic flux amount between the magnetic salient poles 91 and the magnetic teeth 84 is made to be larger, the control device 75 connects the predetermined constant current circuit which sends predetermined current to the armature coils 86 by the induced voltage, and makes the actuator 8m drive the control rod 8k in the direction of a counter clockwise rotation in FIG. 11 by the control signal 76, and thereby, the opposed area between the main magnetic pole 8b and the field magnet 8a is made to be larger.

A constant-voltage power generation system in which the rotating electric machine apparatus serves as an electric generator and by which the field-weakening control is performed to control the power generation voltage to be a predetermined voltage will be explained.

When the power generation voltage that is the output 73 becomes larger than a predetermined value and the magnetic flux amount between the magnetic salient poles 91 and the magnetic teeth 84 is made to be smaller, the control device 75 connects the predetermined constant current circuit which sends predetermined current to the armature coils 86 by the induced voltage, and makes the actuator 8m drive the control rod 8k in the direction of a clockwise rotation in FIG. 11 by the control signal 76, and thereby, the opposed area between the main magnetic pole 8b and the field magnet 8a is made to be smaller.

When the power generation voltage becomes smaller than a predetermined value and the magnetic flux amount between the magnetic salient poles 91 and the magnetic teeth 84 is made to be larger, the control device 75 connects the predetermined constant current circuit which sends predetermined current to the armature coils 86 by the induced voltage, and makes the actuator 8m drive the control rod 8k in the direction of a counter clockwise rotation in FIG. 11 by the control signal 76, and thereby, the opposed area between the main magnetic pole 8b and the field magnet 8a is made to be larger.

In the case of the electric generator, an interaction between the armature and the field magnet part is a force repulsing to each other, and the amount of the magnetic flux flowing through the main magnetic flux pathway is reduced. If this is viewed from the field magnet side, the magnetic resistance of the main magnetic flux pathway is viewed to be effectively larger.

This embodiment applies the above phenomenon to correct the fluctuating magnetic resistance of the main magnetic flux pathway by various tolerances of the settings required for the sizes of the parts in the mass production stage. After assembling the rotating electric machine, the current that enables the magnetic resistance of the main magnetic flux pathway to be effectively equal to the magnetic resistance of the bypass magnetic flux pathway is surveyed each by each, the constant current load that makes the above current flow through the armature coils is set or is memorized in a control device.

The current which flows through the load and the armature coils changes according to rotational speed. Therefore, the constant current load can also be made into the impedance load at each rotational speed. When the load of enough large impedance value is connected to the armature coils 76, the current in the armature coil is too small, the magnetic resistance of the main magnetic flux pathway is the same at rest. This is also involved in the range of this embodiment of the invention.

Since the compensation means of the magnetic resistance of the main magnetic flux pathway adopted in the present embodiment are accompanied by rotor slowdown, when the field control continues over a long time, operation of rotating electric machine may be affected. But a change in the rotating speed and change control of the field strength are performed successively by a usual operational status, so it will not be a big problem. Moreover, when magnetic resistance change of the main magnetic flux pathway is greatly expected by aging changes or temperature change, the composition which acquires the compensation conditions of the magnetic resistance of the main magnetic flux pathway in learning way adopted in the first embodiment is adopted.

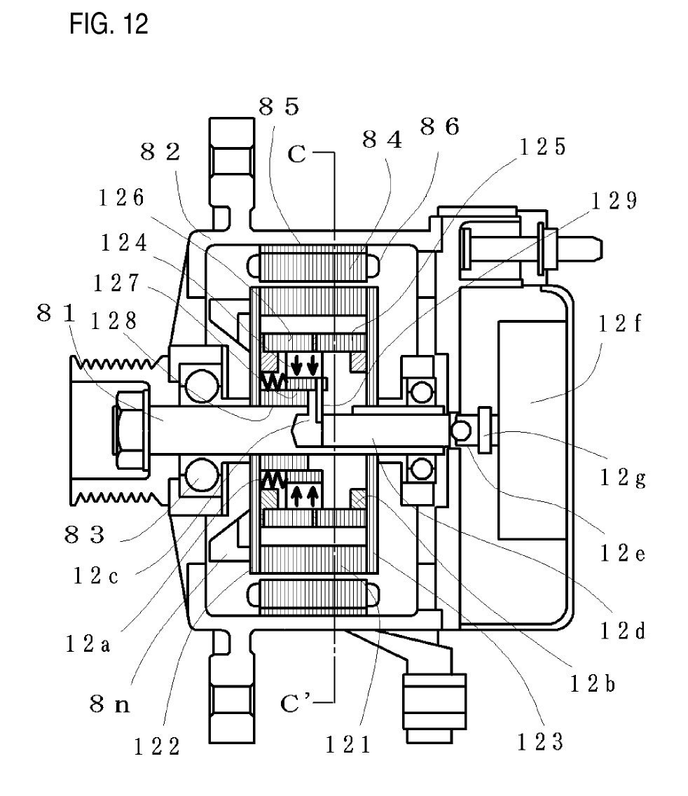

The rotating electric machine system according to a third embodiment of the present invention will be explained by using FIGS. 12 to 14. The third embodiment is a rotating electric machine system in which a rotor having a simple structure the magnetic salient poles and the non-magnetic portions one after the other is disposed, and the magnetic excitation part is disposed in the rotor, and the magnetic flux flowing through the armature is controlled intermittently.

FIG. 12 shows the rotating electric machine apparatus having a radial gap structure, the rotational shaft 81 is supported rotatably by a housing 82 through bearings 83. The composition of the armature is same as the second embodiment indicated in FIG. 9, so the explanation thereof is omitted.

The rotor has a simple magnetic pole part 121 in which the magnetic salient poles and the non-magnetic portions are lined one after the other in the circumferential direction, and are disposed so that the adjacent magnetic salient poles are extended each other to different axial directions, and extended magnetic salient pole parts serve as a first extension part 122 and a second extension part 123 according to the extended axial direction.

The magnetic excitation part is disposed at inside of the magnetic pole part 121, and is connected to the first extension part 122 and the second extension part 123 magnetizing the adjacent magnetic salient poles to be different direction from each other, and the main part thereof includes a field magnet 124, a main magnetic pole 125, a bypass magnetic pole 126, and a base magnetic part 128. The field magnet 124 is fixed to a magnetic excitation part support 127, and they are disposed between the main magnetic pole 125, the bypass magnetic pole 126 and the base magnetic part 128, and are composed to be slid in an axial direction. Above parts which compose the magnetic excitation part are cylindrical shape made of magnetic material.

The displacement control means for controlling displacement of the field magnet 124 and the magnetic excitation part support 127 includes a spring 12a, a control rod 12d which is contained in the hollow of the rotational shaft 81, a push rod 12e, and an actuator 12f. Each of pins 129 fixed to the magnetic excitation part support 127 is made to engage with the control rod 12d through a slit 12c. A cylindrical nonmagnetic material 12b is arranged as the means to regulate displacement range of the field magnet 124. The number 12g represents a torque sensor.

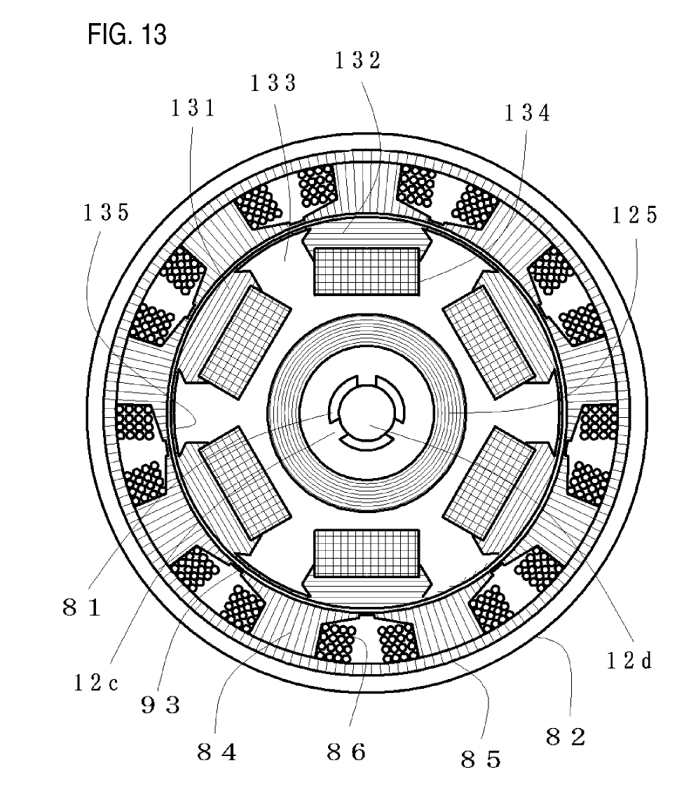

FIG. 13 shows a sectional view of the armature and the rotor along the C-C′ in FIG. 12, and some component parts are appended with numbers for explaining the mutual relations. The disposition of the armature is the same with the second embodiment and therefore the explanation thereof will be omitted.

In FIG. 13, the rotor has a structure having the magnetic salient poles and the non-magnetic portions one after the other in the circumferential direction, and the adjacent magnetic salient poles are shown by numbers 131, 132, and the non-magnetic portions are shown by number 133. Number 134 shows a magnetic-flux channel portion. In this third embodiment, cross sectional area of the magnetic salient poles 131, 132 is not so large, then the magnetic-flux channel portion 134 that has wide cross sectional area exploiting the inside empty space is disposed. Therefore the enough amount of magnetic flux can flow in the magnetic-flux channel portion 134.

The magnetic salient poles 131, 132 that are conjugated by small width saturable magnetic junctions 135 are composed by punching out a silicon steel plate by a predetermined die and stacking the punched-out plates. The non-magnetic portion 133 between the magnetic salient poles 131, 132 is composed in non-magnetic resin or the like having large specific resistance.

In the present embodiment, the magnetic flux channel portion 134 with a large cross-section area constituted from iron with big saturation magnetic flux density is arranged to the magnetic salient pole of a side further than the armature using a rotor empty space. In the magnetic material of stacked silicon steel plates, the magnetic resistance becomes higher in the stacking direction, the magnetic flux channel portion 134 can transfer large amount of the magnetic flux along the rotational shaft 81. Even if the whole magnetic salient pole is composed by isotropic magnetic material, for example, big powder compacting iron core and ferrite, etc., the magnetic resistance of the magnetic salient pole along the rotational shaft 81 can be made small. However, the cross-sectional area of the magnetic salient pole is not large, it is desirable to arrange the wide area and isotropic magnetic material with big saturation magnetic flux density in empty space as in the present embodiment.

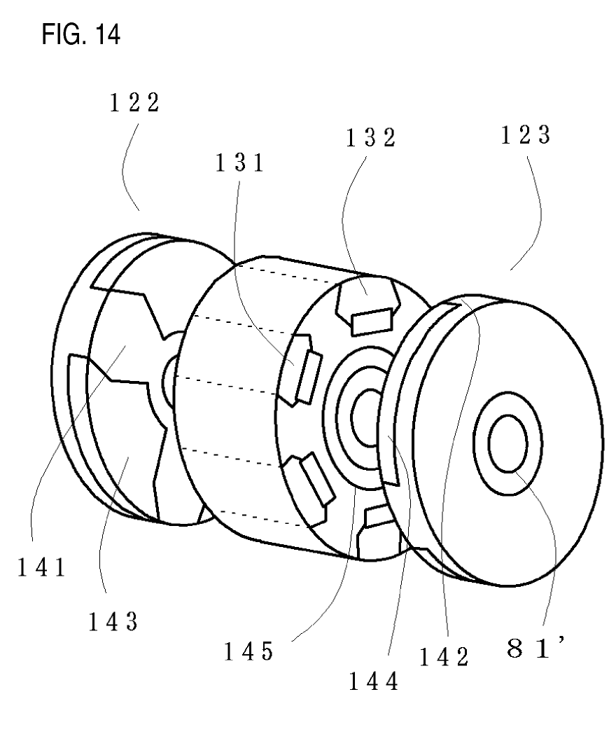

FIG. 14 is a perspective view showing the rotor. In order to make an understanding easy, a main part including the magnetic salient poles 131, 132 and the first extension part 122 and the second extension part 123 are separately illustrated. The number 81′ represents a hole for the rotational shaft 81. The first extension part 122 has a magnetic salient part 141 that corresponds to the magnetic salient pole 131, and is molded. A non magnetic portion 143 is made from non-magnetic stainless steel. The second extension part 123 has a magnetic salient part 142 that corresponds to the magnetic salient pole 132, and is molded. A non magnetic portion 144 is made from non-magnetic stainless steel. The number 145 represents a part of the magnetic excitation part.

A longitudinal sectional view of the composition of the magnetic excitation part is indicated in FIG. 12. The main part thereof is cylindrical shape, and the main magnetic pole 125 and the bypass magnetic pole 126 are lined in an axial direction, the main magnetic pole 125 is connected to the second extension part 123, and the bypass magnetic pole 126 is magnetically connected to the first extension part 122 through a micro nonmagnetic gap. The base magnetic part 128 is connected to the first extension part 122. The field magnet 124 is fixed on the magnetic excitation part support 127, and is arranged possible to slide between the main magnetic pole 125, the bypass magnetic pole 126, and the base magnetic part 128. The magnetization direction of the field magnet 124 is radial direction, and arrows thereof show the magnetization direction.

The main magnetic flux pathway includes the main magnetic pole 125, the second extension part 123, the magnetic salient pole 132, the magnetic teeth 84, the magnetic salient pole 131, the first extension part 122, the base magnetic part 128, and the magnetic excitation part support 127. The bypass magnetic flux pathway includes the bypass magnetic pole 126, the first extension part 122, the base magnetic part 128, and the magnetic excitation part support 127. Gap length of the nonmagnetic gap between the bypass magnetic pole 126 and the first extension part 122 is adjusted so that an average value of the magnetic resistance of the main magnetic flux pathway and the magnetic resistance of the bypass magnetic flux pathway are approximately equal.

According to an axial displacement of the field magnet 124, a ratio of an area of the field magnet 124 opposed to the main magnetic pole 125 and an area of the field magnet 124 opposed to the bypass magnetic pole 126 can be changed with maintaining a sum of the areas to be constant. Thereby, an amount of magnetic flux flowing through the main magnetic flux pathway can be changed, and therefore, a magnetic force disturbing the mechanical displacement can be avoided from being generated.

The disposition of the displacement control means shown in FIG.12 that displaces the field magnet 124 with respect to the main magnetic pole 125 and the bypass magnetic pole 126, and controls an amount of magnetic flux to be supplied between the magnetic salient poles 131, 132 is explained below.

Three of pin 129 fixed on the magnetic excitation part support 127 are in contact with the control rod 12d through three of slit 12c set up to rotational shaft 81. The control rods 12d is constituted possible to slide in an axial direction in the hollow part of the rotational shaft 81, and is in contact with the push rod 12e of the actuator 12f.

The magnetic excitation part support 127 is composed to be biased to the right direction by the spring 12a, and biased to the left direction by the push rod 12e by the actuator 12f, and stops at the axial position in which the both forces are balanced. Therefore, the position of the field magnet 124 and the magnetic excitation part support 127 can be displaced by the actuator 12f in an axial direction.

Furthermore, in this embodiment, the predetermined constant current load is connected to the armature coil 86 at the time of changing magnetic flux in the armature like the case of the second embodiment. Parameters for the predetermined constant current load are acquired in learning way during operation of the rotating electric machine system.

The composition and the procedure which acquire the predetermined constant current load parameters to adjust magnetic resistance of the main magnetic flux pathway effectively in learning way are explained using FIGS. 6 and 12. The number 12g represents a torque sensor. If a difference is in the magnetic resistance of the main magnetic flux pathway and the bypass magnetic flux pathway, the field magnet 124 will receive the magnetic force to displace in the direction which increases the opposite area between the field magnet 124 and the magnetic pole of the magnetic flux pathway with smaller magnetic resistance, and it is possible to detect the above-mentioned magnetic force by the torque sensor 12g.

In the learning section 61 of FIG. 6, the control device connects a constant current circuitry (not shown in the figures), and changes parameters so that different average current flows in the armature coil 86, and watches the torque sensor 12g output in the period. The current conditions from which the torque sensor 12g output becomes small are conditions which make effectively equal the magnetic resistances of the main magnetic flux pathway and the bypass magnetic flux pathway, and the control device memorizes them or set them again as the predetermined constant current load conditions.

The number 62 represents a field control section. The predetermined constant current load is connected to the armature coil 86 on the conditions acquired by the learning process, the actuator 12f is controlled simultaneously, and the field magnet 124 is made to displace in the axial direction. Because magnetic resistances of the main magnetic flux pathway and the bypass magnetic flux pathway are made effectively almost equal, the control by the actuator 12f is performed smoothly. In this case, the rotor is decelerated even for a short time, then the rotating speed 63 changes. The rotor is decelerated during the field control section 62, it is little, but the decelerated state is indicated by the rotating speed 63.

As described above, in the rotating electric machine apparatus shown in FIGS. 12 to 14, it has been explained that by relatively displacing the field magnet 124 with respect to the main magnetic pole 125 and the bypass magnetic pole 126, the magnetic flux amount between the magnetic salient poles 131 and the magnetic teeth 84 can be controlled at almost 100%. The third embodiment is a system for optimizing the output by controlling the magnetic flux amount, and the control method as the rotating electric machine system will be explained by using FIG. 7.

A rotating electric machine system in which the rotating electric machine apparatus serves as an electric motor and by which the field-weakening control is performed to octimize the rotational force control will be explained.

When the rotational speed that is the output 73 becomes larger than a predetermined value and the magnetic flux amount between the magnetic salient poles 131 and the magnetic teeth 84 is made to be smaller, the control device 75 connects the predetermined constant current load to the armature coil 86 in the time zone of the field control section 62 so that magnetic resistances of the main magnetic flux pathway and the bypass magnetic flux pathway are effectively made equal, and simultaneously makes the actuator 12f move the push rod 12e leftward by the control signal 76, and thereby, the opposed area between the main magnetic pole 125 and the field magnet 124 is made to be smaller.

When the rotational speed becomes smaller than a predetermined value and the magnetic flux amount between the magnetic salient poles 131 and the magnetic teeth 84 is made to be larger, the control device 75 connects the predetermined constant current load to the armature coil 86 in the time zone of the field control section 62, and simultaneously makes the actuator 12f move the push rod 12e rightward by the control signal 76, and thereby, the opposed area between the main magnetic pole 125 and the field magnet 124 is made to be larger.

A constant-voltage power generation system in which the rotating electric machine apparatus serves as an electric generator and by which the field-weakening control is performed to control the power generation voltage to be a predetermined voltage will be explained.

When the power generation voltage that is the output 73 becomes larger than a predetermined value and the magnetic flux amount between the magnetic salient poles 131 and the magnetic teeth 84 is made to be smaller, the control device 75 connects the predetermined constant current load to the armature coil 86 in the time zone of the field control section 62, and simultaneously makes the actuator 12f move the push rod 12e leftward by the control signal 76, and thereby, the opposed area between the main magnetic pole 125 and the field magnet 124 is made to be smaller.

When the power generation voltage becomes smaller than a predetermined value and the magnetic flux amount between the magnetic salient poles 131 and the magnetic teeth 84 is made to be larger, the control device 75 connects the predetermined constant current load to the armature coil 86 in the time zone of the field control section 62, and simultaneously makes the actuator 12f move the push rod 12e rightward by the control signal 76, and thereby, the opposed area between the main magnetic pole 125 and the field magnet 124 is made to be larger.

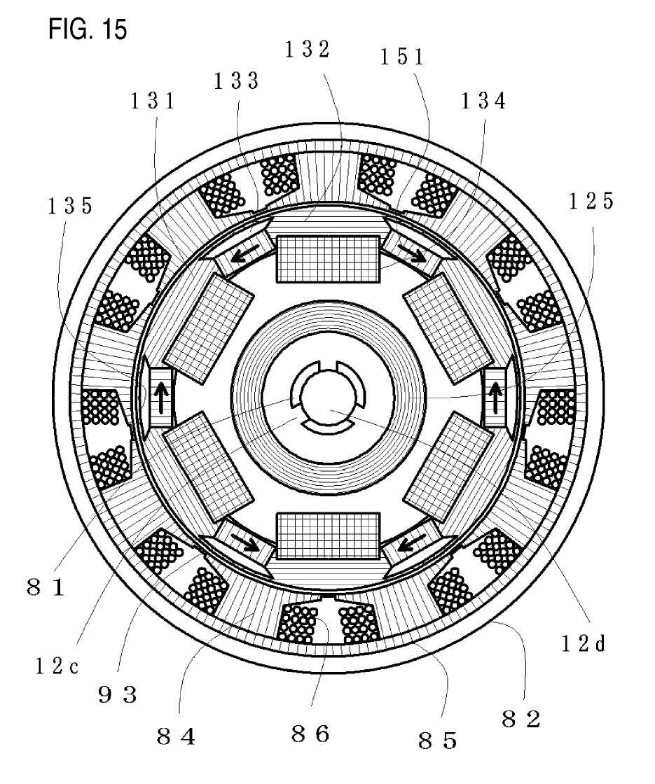

A rotating electric machine system according to a fourth embodiment of the present invention will be explained by using FIG. 15. The fourth embodiment is a rotating electric machine system in which a rotor having a structure the magnetic salient poles and permanent magnets one after the other is disposed and is disposed so that the adjacent magnetic salient poles are excited in different polarities each other, and in which other parts are the same as the third embodiment. Following explanation is focused on different points from the third embodiment.

In FIG. 15, the rotor has a structure in which the magnetic salient pole and a permanent magnet 151 with magnetization of circumferential direction are lined one after the other in the circumferential direction, and the magnetization direction of the adjacent permanent magnets 151 is disposed inversely to each other so that the adjacent magnetic salient poles 131, 132 are magnetized in different directions to each other. The arrow shown in the permanent magnet 151 shows a magnetization direction, then the magnetic salient pole 131 is magnetized in an N-pole, and the magnetic salient pole 132 is magnetized in an S-pole.

The most important point in the fourth embodiment is to dispose the permanent magnet 151 and the magnetic excitation part so that the direction of the magnetization to which the magnetic excitation part excites the magnetic salient poles 131, 132, and the direction to which the permanent magnet 151 magnetizes the magnetic salient poles 131, 132 may be coincided. Referring to FIG. 12, because the fourth embodiment disposition is same as in the third embodiment, the field magnet 124 magnetizes the main magnetic pole 125 in an S-pole, and the main magnetic pole 125 magnetizes the magnetic salient pole 132 in an S-pole through the second extension part 123, and also the field magnet 124 magnetizes the magnetic salient pole 131 in an N-pole through the base magnet part 128 and the first extension part 122.

In above disposition, an amount of the magnetic flux between the magnetic salient poles 131 and the magnetic teeth 84 is a sum of the magnetic flux from the permanent magnets 151 and the one from the magnetic excitation part. And then the amount of the magnetic flux between the magnetic salient poles 131 and the magnetic teeth 84 is controlled by controlling the amount of magnetic flux from the magnetic excitation part.

Because only the fourth embodiment slightly changed the magnetic pole composition of the rotor in the third embodiment, the operating principle to control the field strength between the rotor and the armature is same as the third embodiment and therefore the explanation thereof will be omitted.

In this embodiment, the permanent magnet 151 and the magnetic excitation part are arranged so that both may magnetize the magnetic salient poles in the same direction. When this is reverse, the permanent magnet 151 and the field magnet 124 constitute a closed magnetic circuit, and this makes the big magnetic power which becomes obstruction on the occasion of displacement control of the field magnet 124 occur, and precise control is difficult.

Existence of the permanent magnet 151 is not desirable in a meaning that the control range of the magnetic flux amount by the magnetic excitation part is narrowed. However, there are the structure of arranging a permanent magnet in a gap between the magnetic salient poles and reducing the magnetic flux short in the gap, and the structure of dividing a uniform magnetic material by a permanent magnet with circumferential direction magnetization and forms magnetic salient poles as well as makes the permanent magnet a magnetic flux barrier. This embodiment is significant as the practical example that enables the field control easy in such conventional rotating electric machine.

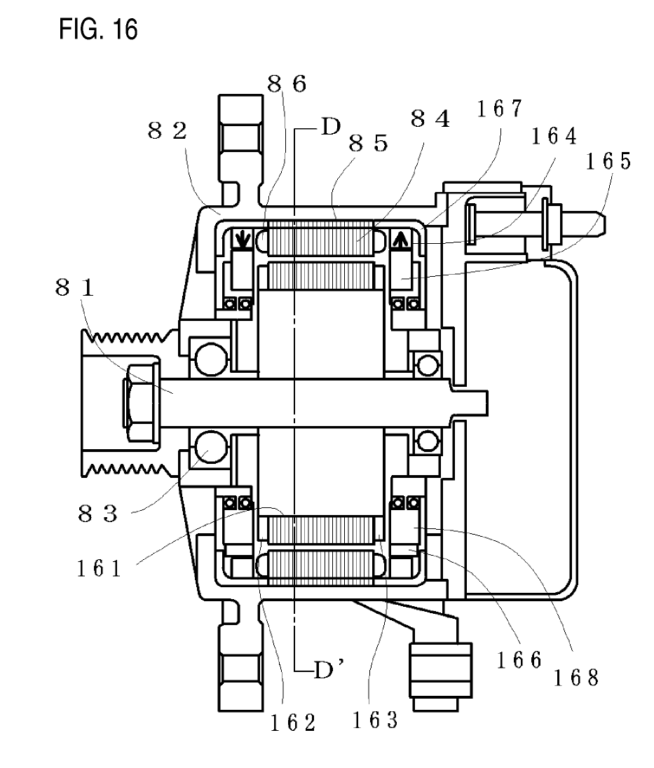

A rotating electric machine system according to a fifth embodiment of the present invention will be explained by using FIGS. 16 to 21. The fifth embodiment is a rotating electric machine system in which the magnetic salient poles and permanent magnet assemblies are arranged alternately in circumferential direction, and the magnetic excitation part is disposed in the static side. Furthermore, the fifth embodiment is the composition in which the electric current of the predetermined condition is supplied to the armature coil at the time of the field strength control, and the resistance of the main magnetic flux pathway and the bypass magnetic flux pathway is equated in the effect, and magnetic power that disturbs the displacement control is made small.

FIG. 16 shows the rotating electric machine apparatus having a radial gap structure, the rotational shaft 81 is supported rotatably by a housing 82 through bearings 83. The composition of the armature is same as the second embodiment indicated in FIG. 9, so the explanation thereof is omitted.

A magnetic pole part 161 structure of the rotor has the disposition that the magnetic salient poles and the permanent magnet assemblies are disposed one after the other in the circumferential direction, and the adjacent magnetic salient poles are extended to different axial directions each other, and extended magnetic salient pole parts serve as a first extension part 162 and a second extension part 163 according to the extended axial direction.

Two magnetic excitation parts are arranged in the housing side facing the first extension part 162 and the second extension part 163 through a gap, and supply the magnetic flux between the cylindrical magnetic yoke 85 and each of the first extension part 162 and the second extension part 163 respectively so that the adjacent magnetic salient poles are magnetized in different directions to each other.

In the figure, a main part of the magnetic excitation part opposing to the second extension part 163 includes the field magnet 164, the main magnetic pole 165, the bypass magnetic pole 166, and the base magnetic pole 167. And, the main magnetic pole 165 and the bypass magnetic pole 166 are supported by a magnetic excitation part support 168, and the magnetic excitation part support 168 is rotatably supported by the housing 82. Although, parts of the magnetic excitation part opposing to the first extension part 162 are not numbered, the magnetic excitation part opposing to the first extension part 162 has the same disposition with the one opposing to the second extension part 163. However, it is arranged so that the magnetization direction of the field magnet 164 may become reverse each other of the magnetic excitation part in the first extension part 162 side or the second extension part 163 side.

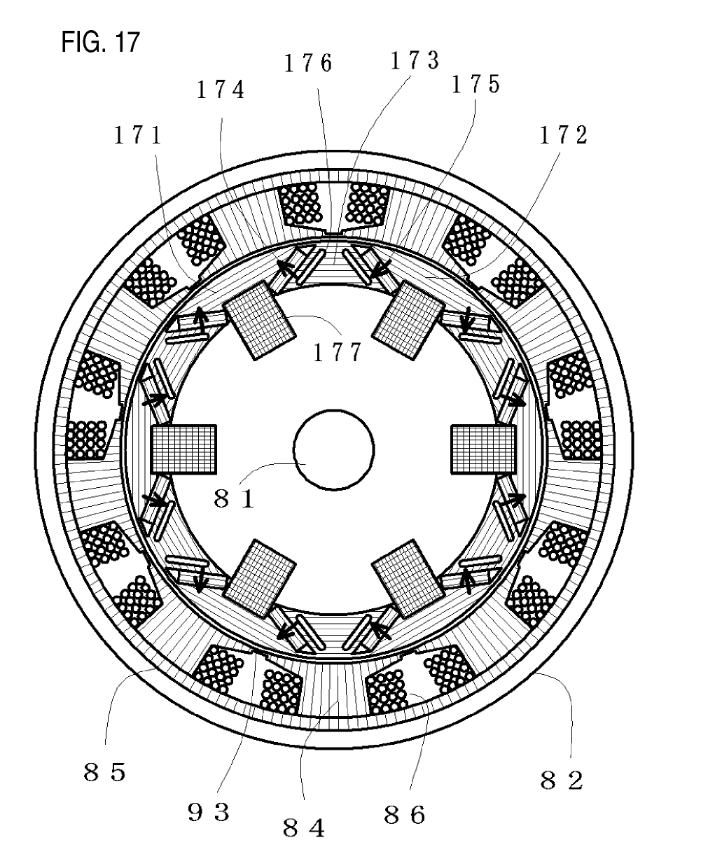

FIG. 17 shows a sectional view of the armature and the rotor along the D-D′ in FIG. 16, and some component parts are appended with numbers for explaining the mutual relations. The disposition of the armature is the same with the second embodiment and therefore the explanation thereof will be omitted.

In FIG. 17, the rotor has a structure in which the magnetic salient poles and the permanent magnet assemblies are disposed one after the other in the circumferential direction. A combination of an intermediate magnetic salient pole 173 and permanent magnet plates 174, 175 that have same magnetization direction and are disposed at both side of the pole 173 serves as the permanent magnet assembly. The surface magnetic pole part is characterized in that a uniform magnetic material is partitioned into the magnetic salient poles 171, 172 by the permanent magnet assemblies in the circumferential direction. And each magnetization direction of the adjacent permanent magnet assemblies is inversely arranged so that the adjacent magnetic salient poles 171, 172 are differently magnetized each other. The disposition shape of the permanent magnet plates 174, 175 that are disposed at the side surface of the magnetic salient poles 171, 172 looks like V-letter, a crossing angle of the V-letter shape is arranged at suitable value for a flux barrier. Arrows appended in the permanent magnet plates 174, 175 show magnetization directions that are perpendicular to the permanent magnet plates 174, 175 face.

The number 177 shows a magnetic-flux channel portion that corresponds to the magnetic-flux channel portion 134 in the third embodiment. In this fifth embodiment, cross sectional area of the magnetic salient poles 171, 172 is not so large, then the magnetic-flux channel portion 177 that has wide cross sectional area exploiting the inside empty space is disposed. Therefore, enough of an amount of magnetic flux can flow in the magnetic-flux channel portion 177. The number 176 represents the non-magnetic portion disposed in the intermediate magnetic salient pole 173 so that a magnetic resistance between the permanent magnet plates 174, 175 becomes large.

The magnetic salient poles 171, 172 and the intermediate magnetic salient pole 173 are composed by punching out a silicon steel plate by a predetermined die and then stacking the punched plates. Then permanent magnet plates are inserted into slots corresponding to the permanent magnet plates 174, 175, and iron blocks are also inserted into slots corresponding to the magnetic-flux channel portion 177.

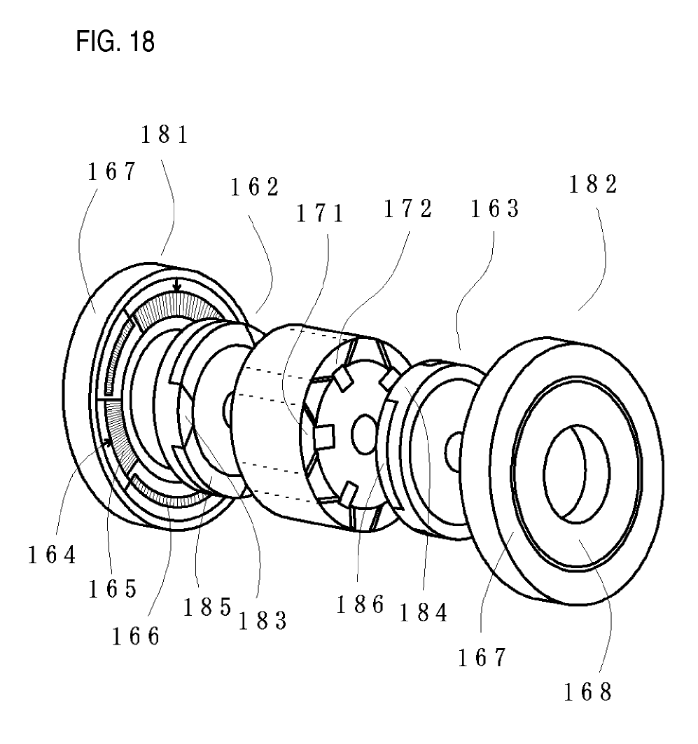

FIG. 18 is a perspective view showing the rotor and the magnetic excitation part. A main part including the magnetic salient poles 171, 172 and the first extension part 162 and the second extension part 163 are separately illustrated for understanding easily.

The first extension part 162 has a magnetic salient part 183 that corresponds to the magnetic salient pole 171, and is molded. A non-magnetic portion 185 is made from non-magnetic stainless steel. The second extension part 163 has a magnetic salient part 184 that corresponds to the magnetic salient pole 172, and is molded. A non-magnetic portion 186 is made from non-magnetic stainless steel.

The magnetic excitation parts 181, 182 are opposing to the first extension part 162 and the second extension part 163 through air gap respectively. Each main magnetic pole 165 of the magnetic excitation parts 181, 182 is magnetically connected to the magnetic salient part 183 in the first extension part 162 and the magnetic salient part 184 in the first extension part 163 respectively. And each base magnetic pole 167 of them is magnetically connected to both ends of the cylindrical magnetic yoke 85 (not shown in FIG. 18) respectively.

Each magnetic excitation part support 168 in the magnetic excitation parts 181, 182 is controlled to displace circumferentially so that relative position between (the main magnetic pole 165 and the bypass magnetic pole 166) and the field magnet 164 is changed.

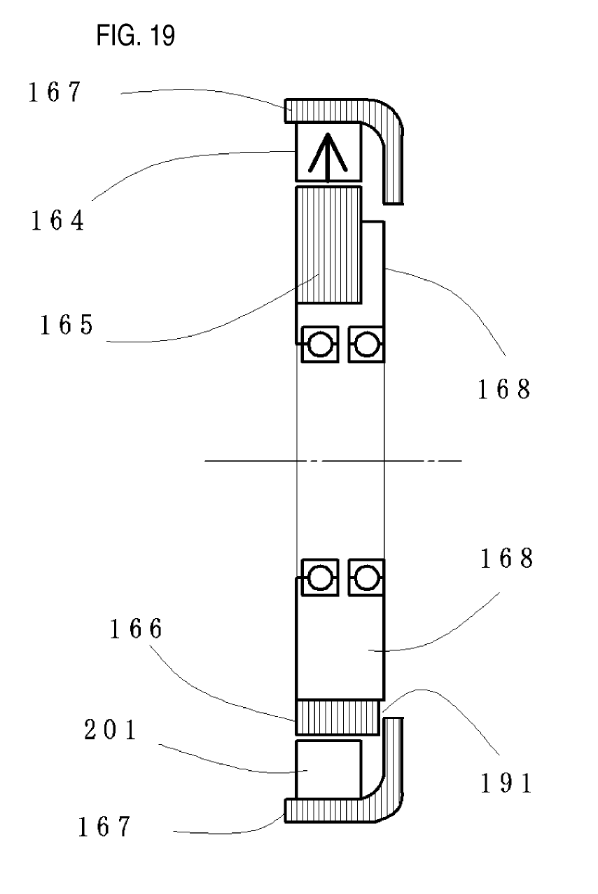

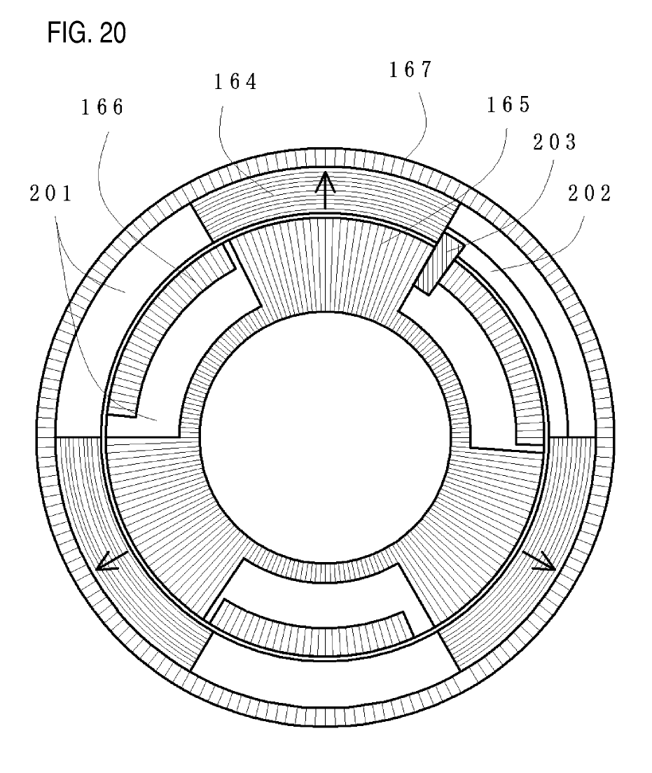

The disposition of the magnetic excitation part will be explained by using FIGS. 19 and 20. FIG. 19 is a magnified longitudinal sectional view showing the magnetic excitation part 182, and FIG. 20 is a magnified plan view showing the magnetic excitation part 182 from the rotor side.

In FIGS. 19 and 20, three field magnets 164 are fixed in the direction of a circumference at equal intervals at the inside of the base magnetic pole 167, and the main magnetic pole 165 and the bypass magnetic pole 166 are arranged along with the direction of a circumference opposing to each field magnet 164 in a radial direction. The field magnet 164 is always opposing to the main magnetic pole 165 and the bypass magnetic pole 166, and the sum of the respective opposed areas of the main magnetic pole 165 and the bypass magnetic pole 166 is constant, and therefore, the ratio of the areas is changed according to the displacement. The number 201 represents the non-magnetic portion disposed so that a magnetic flux leakage is prevented.

The main magnetic pole 165 is magnetically connected to the magnetic salient part 184 of the second extension part 163 through air gap, the bypass magnetic pole 166 is magnetically connected to the base magnetic pole 167 through a micro air gap 191. In the magnetic excitation part 182 of this embodiment, the magnetic flux flowing from the field magnet 164 to the main magnetic pole 166 forms a main magnetic flux pathway circulating to the base magnetic pole 167 through the magnetic salient part 184 of the second extension part 163, the magnetic salient poles 172, the magnetic teeth 84, and the cylindrical magnetic yoke 85. The magnetic flux flowing into the bypass magnetic pole 166 forms a bypass magnetic flux pathway circulating to the base magnetic pole 167 through the micro air gap 191. Magnetic resistances of the main magnetic flux pathway and the bypass magnetic flux pathway are set to be equal by adjusting an opposing area and the gap length of the micro air gap 191.

The magnetic salient poles 171, 172 are magnetized by the permanent magnet plates 174, 175, then the magnetic salient pole 171 is an N-pole, and the magnetic salient pole 172 is an S-pole. The most important point in this embodiment is to dispose the permanent magnet plates 174, 175 and the magnetic excitation parts so that magnetization direction of the magnetic salient poles 171, 172 by the magnetic excitation parts 181, 182 and the one by the permanent magnet plates 174, 175 may become the same. In the magnetic excitation part 181, the field magnet 164 magnetizes the main magnetic pole 165 in an N-pole, and the main magnetic pole 165 magnetizes the magnetic salient pole 171 in an N-pole. And also in the magnetic excitation part 182, the field magnet 164 magnetizes the main magnetic pole 165 in an S-pole, and the main magnetic pole 165 magnetizes the magnetic salient pole 172 in an S-pole.

Thus, the permanent magnet plates 174, 175 and the magnetic excitation part 181 magnetize the magnetic salient poles 171 respectively in the same polarity. The role of the permanent magnet plates 174, 175 which constitutes the permanent magnet assemblies is a magnetic flux barrier for forming the domain of big magnetic resistance in the direction of a circumference while generating the magnetic flux. In this embodiment, the purpose of the magnetic excitation parts 181, 182 is to supply the magnetic flux and to control it. Therefore, the magnetic flux from the permanent magnet plates 174, 175 is the existence acting as an obstacle from a view point of magnetic flux control. The non-magnetic portion 176 prepared in the intermediate magnetic salient pole 173 is disposed so that a magnetic resistance between the permanent magnet plates 174, 175 becomes large.

In FIG. 20, an air gap 202 and a salient part 203 disposed in the non-magnetic portion 201 provide displacement regulating means for binding the main magnetic pole 165 and the bypass magnetic pole 166 into the displacement in the predetermined range. The salient part 203 is fixed to the side of the main magnetic pole 165 and the bypass magnetic pole 166, and the displacement of the salient part 203 is limited between the adjacent filed magnets 164.

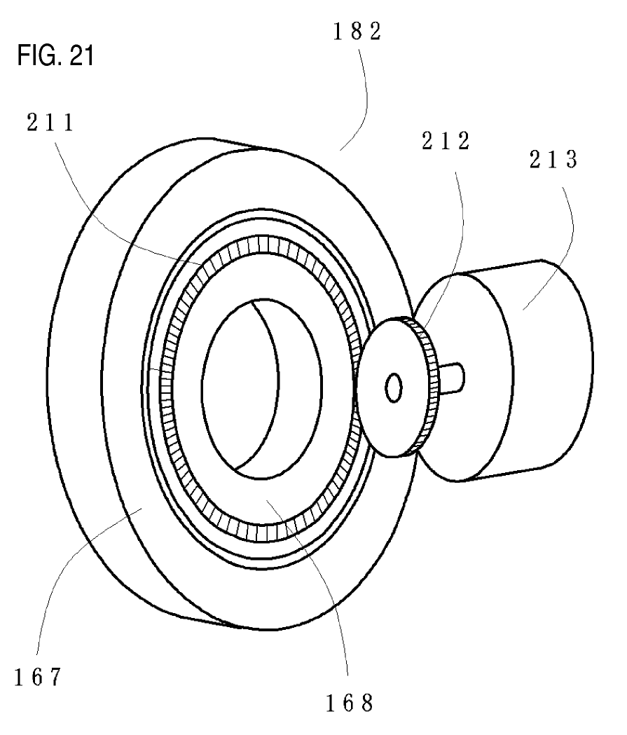

FIG. 21 is a perspective view showing the displacement control means to displace the main magnetic pole 165 and the bypass magnetic pole 166 with respect to the field magnet 164. In the figure, a gear 211 is disposed at an end of the magnetic excitation part support 168 and then a step motor 213 with a gear 212 is disposed so that the gear 212 is bitten with the gear 211. The step motor 213 and the gears 211, 212 keep position of the main magnetic pole 165 and the bypass magnetic pole 166, and displace them with respect to the field magnets 164, and control the amount of the magnetic flux between the magnetic salient poles 172 and the magnetic teeth 84. The magnetic excitation part 181 also has the same displacement control means.

The present embodiment does not have the means for adjusting the magnetic resistance of the bypass magnetic flux pathway as adopted in the first embodiment. However, a driving circuitry is connected to the armature coils 86 at the time of displacement control of the main magnetic pole 165 and the bypass magnetic pole 166, and supplies the predetermined current to accelerate or to decelerate the rotor so that magnetic resistance of the main magnetic flux pathway is adjusted effectively and the magnetic power which becomes an obstacle of the above-mentioned displacement control is made small.

After assembling the rotating electric machine, relating supply current parameters that enables the magnetic resistance of the main magnetic flux pathway to be effectively equal to the bypass magnetic flux pathway are surveyed and memorized in a control device. When the main magnetic pole 165 and the bypass magnetic pole 166 are displaced with respect to the field magnet 164, the driving current is supplied to the armature coils 86 according to the predetermined condition, and then the magnetic force preventing the displacement is maintained small.

As described above, in the rotating electric machine apparatus shown in FIGS. 16 to 21, it has been explained that by relatively displacing the main magnetic pole 165 and the bypass magnetic pole 166 with respect to the field magnet 164, the magnetic flux amount between the magnetic salient poles 171 and the magnetic teeth 84 can be controlled, and furthermore, the means and the method for displacing the main magnetic pole 165 and the bypass magnetic pole 166 with respect to the field magnet 164 have been explained. The fifth embodiment is a system for optimizing the output by controlling the magnetic flux amount, and the control method as the rotating electric machine system will be explained by using FIG. 7.

A rotating electric machine system in which the rotating electric machine apparatus serves as an electric motor and by which the field-weakening control is performed to octimize the rotational force control will be explained.

When the rotational speed that is the output 73 becomes larger than a predetermined value and the magnetic flux amount between the magnetic salient poles 171, 172 and the magnetic teeth 84 is made to be smaller, the control device 75 supplies the predetermined driving current to the armature coils 86 so that magnetic resistances of the main magnetic flux pathway and the bypass magnetic flux pathway are made effectively equal, and displaces the main magnetic pole 165 and the bypass magnetic pole 166 clockwise in FIG. 20 through the step motor 213 in the magnetic excitation parts 181, 182, and thereby, the opposed area between the main magnetic pole 165 and the field magnet 164 is made to be smaller.

When the rotational speed becomes smaller than a predetermined value and the magnetic flux amount between the magnetic salient poles 171, 172 and the magnetic teeth 84 is made to be larger, the control device 75 supplies the predetermined driving current to the armature coils 86, and displaces the main magnetic pole 165 and the bypass magnetic pole 166 counterclockwise in FIG. 20 through the step motor 213 in the magnetic excitation parts 181, 182, and thereby, the opposed area between the main magnetic pole 165 and the field magnet 164 is made to be larger.

A constant-voltage power generation system in which the rotating electric machine apparatus serves as an electric generator and by which the field-weakening control is performed to control the power generation voltage to be a predetermined voltage will be explained.

When the power generation voltage that is the output 73 becomes larger than a predetermined value and the magnetic flux amount between the magnetic salient poles 171, 172 and the magnetic teeth 84 is made to be smaller, the control device 75 supplies the predetermined driving current to the armature coils 86, and displaces the main magnetic pole 165 and the bypass magnetic pole 166 clockwise in FIG. 20 through the step motor 213 in the magnetic excitation parts 181, 182, and thereby, the opposed area between the main magnetic pole 165 and the field magnet 164 is made to be smaller.

When the power generation voltage becomes smaller than a predetermined value and the magnetic flux amount between the magnetic salient poles 171, 172 and the magnetic teeth 84 is made to be larger, the control device 75 supplies the predetermined driving current to the armature coils 86, and displaces the main magnetic pole 165 and the bypass magnetic pole 166 counterclockwise in FIG. 20 through the step motor 213 in the magnetic excitation parts 181, 182, and thereby, the opposed area between the main magnetic pole 165 and the field magnet 164 is made to be larger.

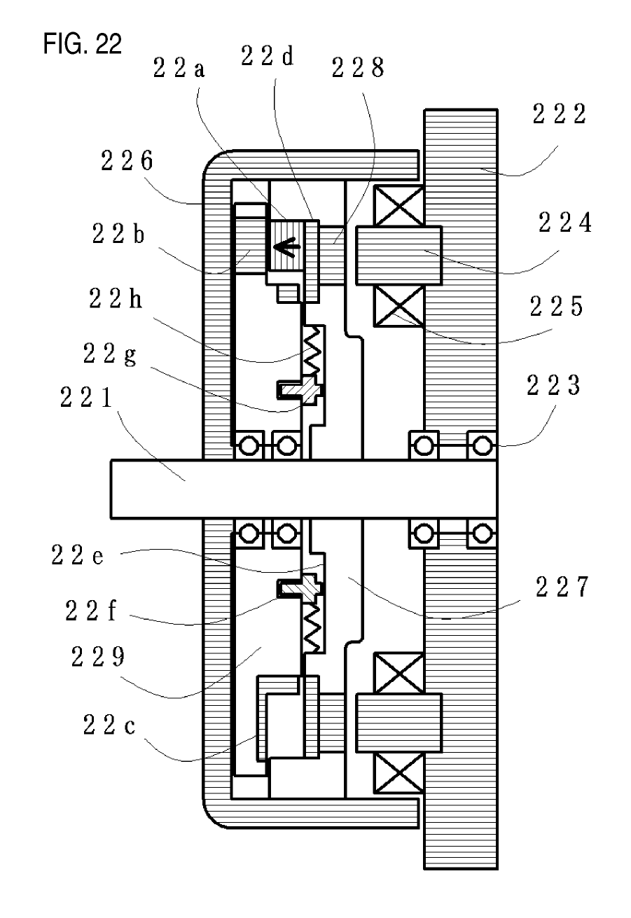

A rotating electric machine system according to a sixth embodiment of the present invention will be explained by using FIGS. 22 to 25(b). The sixth embodiment is a rotating electric machine system having a unipolar rotor with an axial gap structure. The magnetic excitation part is disposed in the rotor, and controls the magnetic flux amount by a governor mechanism.

FIG. 22 illustrates the rotating electric machine apparatus with an axial gap structure, and a rotating shaft 221 is supported rotatably through bearings 223 by an iron substrate 222. An armature is fixed to the iron substrate 222, and includes a plurality of magnetic teeth 224 extending in the axial directions from the substrate 222 and armature coils 225 wound around the magnetic teeth 224. Nine armature coils 225 are included and connected so as to have three phases.

The rotor has a surface magnetic pole part 227 and a movable magnetic pole part 229 and a cup 226. The surface magnetic pole part 227 and the cup 226 are fixed to the rotating shaft 221. The movable magnetic pole part 229 is supported rotatably through bearings by the rotating shaft 221 opposing by the surface magnetic pole part 227 and the cup 226 through a micro gap.

The surface magnetic pole part 227 includes circle-shaped base magnetic pole 22d arranged on a large electrical resistance resin board and the magnetic salient poles 228 are disposed on the base magnetic plate 22d of the magnetic teeth 224 side and a field magnet 22a is arranged on the other side of the base magnetic plate 22d from the magnetic teeth 224. The base magnetic plate 22d is composed by stacking circular silicon steel plates so that alternating magnetic flux can pass through.

The movable magnetic pole part 229 includes a main magnetic pole 22b and a bypass magnetic pole 22c arranged on a non-magnetic stainless steel base. The cup 226 is made of iron, and outer periphery of the cup 226 is opposing to the substrate 222 so that the magnetic flux can propagate from the main magnetic pole 22b to the substrate 222 through the cup 226.

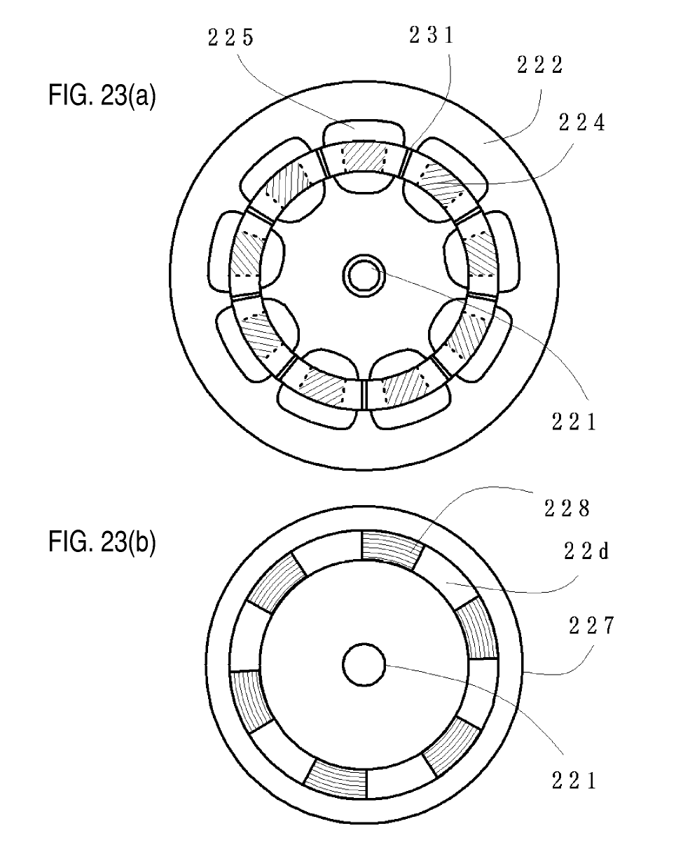

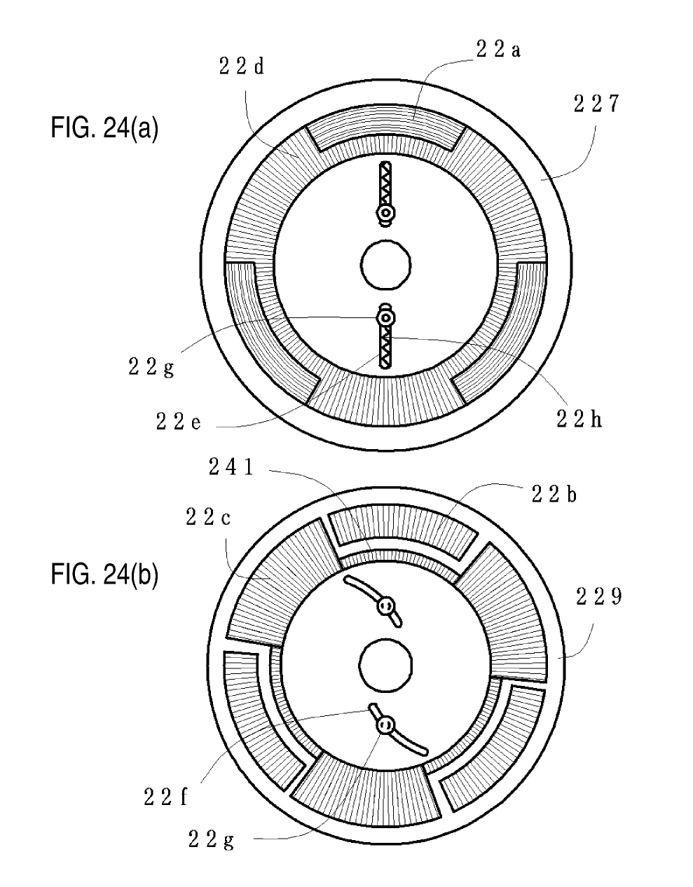

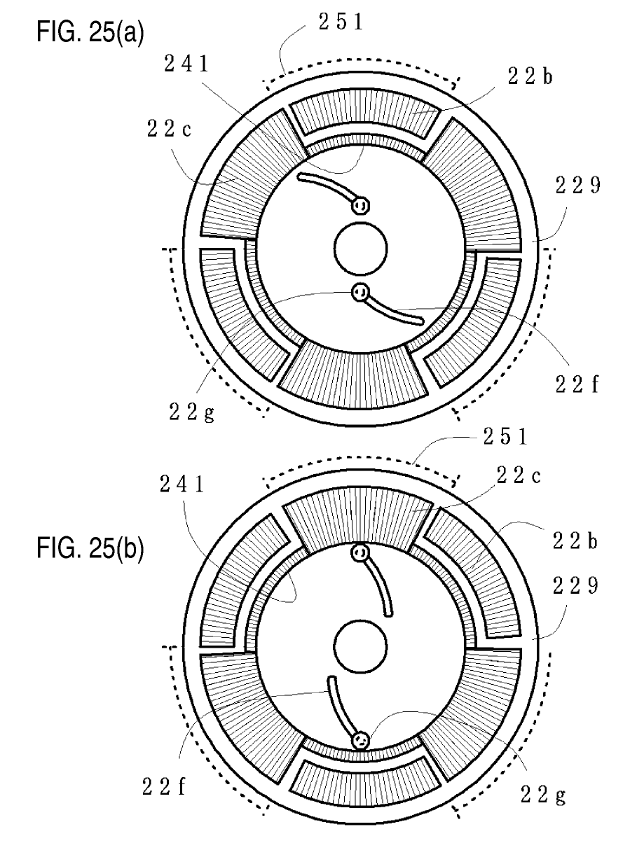

The movable magnetic pole part 229 rotates with the rotating shaft 221, the cup 226, and the surface magnetic pole part 227, and changes the relative position of the circumferential direction with respect to the rotating shaft 221, the cup 226, and the surface magnetic pole part 227 according to the rotating speed by centrifugal force. A radial guide groove 22e and a spring 22h arranged at the surface magnetic pole part 227, and an arc-shaped guide groove 22f and a weight 22g arranged at the movable magnetic pole part 229 are a part of above displacement means. Details are explained later using FIGS. 24(a), 24(b), 25(a), and 25(b). FIG. 23(a) is a plan view showing the armature from the surface magnetic pole part 227 side, and some of the component parts are appended with numbers for explaining the reciprocal relation.

The magnetic teeth 224 are T character-like structures, and while the portion by which the hatch was carried out is fixed by the iron substrate 222, the armature coils 225 are wound around. At an opposing surface to the surface magnetic pole part 227, the adjacent magnetic teeth 224 are facing each other through a micro gap 23 1. In the sixth embodiment, nine armature coils 225 are included and connected so as to have three phases. The iron substrate 222 forms a part of the main magnetic flux pathway with the magnetic teeth 224.

FIG. 23(b) is a plan view showing the surface magnetic pole part 227 from the magnetic teeth 224 side. Six magnetic salient poles 228 are arranged at equal intervals on the circle-like base magnetic plate 22d of the surface magnetic pole part 227.

The magnetic excitation part includes the surface magnetic pole part 227 and the movable magnetic pole part 229. FIG. 24(a) is a plan view showing the surface magnetic pole part 227 from the movable magnetic pole part 229 side. Three field magnet 22a are arranged at equal intervals on the circle-like base magnetic plate 22d of the surface magnetic pole part 227.

FIG. 24(b) is a plan view showing the movable magnetic pole part 229 from the cup 226 side. The main magnetic pole 22b and the bypass magnetic pole 22c are opposite to the field magnet 22a through a micro gap, and the bypass magnetic pole 22c connects with a bypass magnetic material 241, and the bypass magnetic material 241 is opposing to the base magnetic plate 22d through a micro gap. The axial length of the main magnetic pole 22b is longer than the bypass magnetic pole 22c, and is magnetically combined with the cup 226 through a minute gap.

In FIGS. 24(a) and 24(b), the governor mechanism that displaces the movable magnetic pole part 229 with respect to the cup 226 and the surface magnetic pole part 227 according to rotational speed is shown. The weight 22g is disposed in the radial guide groove 22e and the arc-shaped guide groove 22f, and is biased to move toward inner direction by the spring 22h disposed in the radial guide groove 22e. Although the arc-shaped guide groove 22f is arranged at the surface magnetic pole part 227 side of the movable magnetic pole part 229, in order to make it intelligible, the solid line shows them with 22g of weight in FIG. 24(b).

The standard position of the weight 22g is a position in the standstill which centrifugal force does not work, and the weight 22g is located in the innermost radius. When the rotational speed increases, the centrifugal force and the spring 22h will push one another, and the weight 22g moves to the balancing diameter position. The arc-shaped guide groove 22f receives the power of the circumferential direction and makes the movable magnetic pole part 229 displace relatively to the surface magnetic pole part 227 and the cup 226 by its process. Then FIG. 24(b) indicates the example which the weight 22g moved to the perimeter side slightly from the standard position.

Furthermore, displacement of the movable magnetic pole part 229 increases according to the rotational speed and becomes biggest by a point to a termination of the guide groove 22e of radial direction or the arc-shaped guide groove 22f, and the size of the guide groove 22e or the arc-shaped guide groove 22f is made into the regulation means of the displacement of the movable magnetic pole part 229.

FIG. 25(a) shows the main magnetic pole 22b and the bypass magnetic pole 22c in the standard position, and FIG. 25(b) shows the main magnetic pole 22b and the bypass magnetic pole 22c which carried out the maximum displacement. The principle which controls the amount of magnetic flux between the magnetic salient pole 228 and the magnetic teeth 224 using from FIGS. 22 to 25(b) will be explained.

The magnetic flux from the field magnet 22a possesses the main magnetic flux pathway and the bypass magnetic flux pathway which are two magnetic flux pathways. The main magnetic flux pathway is the magnetic flux pathway where the magnetic flux from the one end of the field magnet 22a returns to the other end through the main magnetic pole 22b, the cup 226, the substrate 222, the magnetic teeth 224, the magnetic salient pole 228, and the base magnetic pole part 22d. The bypass magnetic flux pathway is the magnetic flux pathway where the magnetic flux from the one end of the field magnet 22a returns to the other end through the bypass magnetic pole 22c, the bypass magnetic material 241, and the base magnetic pole part 22d. In this embodiment, the opposing area in the gap and a gap length between the bypass magnetic material 241 and the base magnetic pole part 22d are being adjusted so that magnetic resistance of the bypass magnetic flux pathway may be set up almost equally to the magnetic resistance of the main magnetic flux pathway.

The field magnet 22a always opposes with the main magnetic pole 22b and the bypass magnetic pole 22c, and the summation of its opposite area is constant, and corresponding to the displacement between the field magnet 22a and the combination of the main magnetic pole 22b and the bypass magnetic pole 22c, the ratio of the opposite area is constituted so that it may change.

The magnetic flux from the field magnet 22a is shunted toward the main magnetic pole 22b and the bypass magnetic pole 22c according to an opposing area ratio, and returns to the field magnet 22a through the main magnetic flux pathway and the bypass magnetic flux pathway, respectively. The magnetic resistances of the main magnetic flux pathway and the bypass magnetic flux pathway are equal mostly, and the summation of the areas by which field magnet 22a opposes in each of the main magnetic pole 22b and the bypass magnetic pole 22c is fixed, so the magnetic flux amount from the field magnet 22a is always fixed. Therefore, magnetic force which prevents the displacement of the main magnetic pole 22b, and the bypass magnetic pole 22c with respect to the field magnet 22a, is not generated.

In FIGS. 25(a) and 25(b), the dotted line 251 shows the circumferential position of the field magnet 22a. When being stationary, centrifugal force does not operate on the weight 22g, so it is forced by the spring 22h into the standard location of the innermost radius, and the opposite area with the main magnetic pole 22b and the field magnet 22a is biggest, and the biggest amount of magnetic flux is flowing through the space between the magnetic salient poles 228 and the magnetic teeth 224.

Then rotational speed is high in FIG. 25(b), the centrifugal force which acts on weight 22g wins the force of the spring 22h and makes the weight 22g move to the most part of outskirts in the guide groove 22f or the guide groove 22e, and the relative displacement of the main magnetic pole 22b and the bypass magnetic pole 22c with respect to the field magnet 22a becomes maximum, and the opposite area with the main magnetic pole 22b and the field magnet 22a becomes minimum, and amount of the magnetic flux which flows between the magnetic salient poles 228 and the magnetic teeth 224 is made into the minimum.

In this embodiment, it was shown that the main magnetic pole 22b and the bypass magnetic pole 22c are displaced with respect to the field magnet 22a according to rotational speed, and the amount of magnetic flux which interlinks with the armature coils 225 can be controlled. Since magnetic force is not theoretically generated on the occasion of the displacement of the main magnetic pole 22b and the bypass magnetic pole 22c in this invention, smooth control is possible. The relationship between rotational speed and the displacement depends on the specification of the weight 22g and the spring 22h and the shape of the guide groove 22f, etc. Although there is demerit which lacks correctness for control of the interlinking magnetic flux amount with the armature coils 225 like this embodiment, there is a merit in making a special control device unnecessary by a simple mechanism.

The sixth embodiment is the rotating electric machine system of a unipolar axial gap structure. The composition which arranges the magnetic excitation pole part to the stillness side between the cup 226 and the substrate 222 like the first embodiment is also possible, and the weight saving of the rotor can be carried out in that case.

Moreover, although this embodiment has a unipolar rotor, the rotating electric machine of the axial gap structure which magnetizes adjacent magnetic salient poles to the different polarities each other is also possible of course. In this case, the adjacent magnetic salient poles are extended to different radial directions each other, and extended magnetic salient pole parts serve as a first extension part and a second extension part according to the extended radial direction, and the magnetic excitation part is disposed in the rotor or at the housing side, and the first extension part and the second extension part are magnetically connected to the main magnetic pole and the second magnet end, respectively so as to magnetize the adjacent magnetic salient poles in different polarities each other.

In the rotating electric machine of the axial gap structure, air gap control between an armature and a field magnet part seems to be easy, and there are many prior art proposals to control magnetic field intensity by changing the air gap length. However, between the armature and the field magnet part, attracting force is always working, and it is necessary to adopt the high power actuator as gap control between them, or to adopt a gear down mechanism as it at the sacrifice of response time. Furthermore, when the gap between the armature and the field magnet part becomes large, leakage flux distribution spreads, therefore rotation drive control meets some kind of trouble, and the control range of magnetic field intensity is also limited.

According to this embodiment, there is no generating of the magnetic force which prevents the displacement theoretically on the occasion of the displacement of main magnetic pole 22b and bypass magnetic pole 22c, and the magnetic flux which interlinks the armature coils 225 can be decreased even to zero. Furthermore, there is the strong point made to a compact rotating electric machine system with the short length in the axial direction as compared with the structure of adjusting the gap length between the armature and the field magnet part.

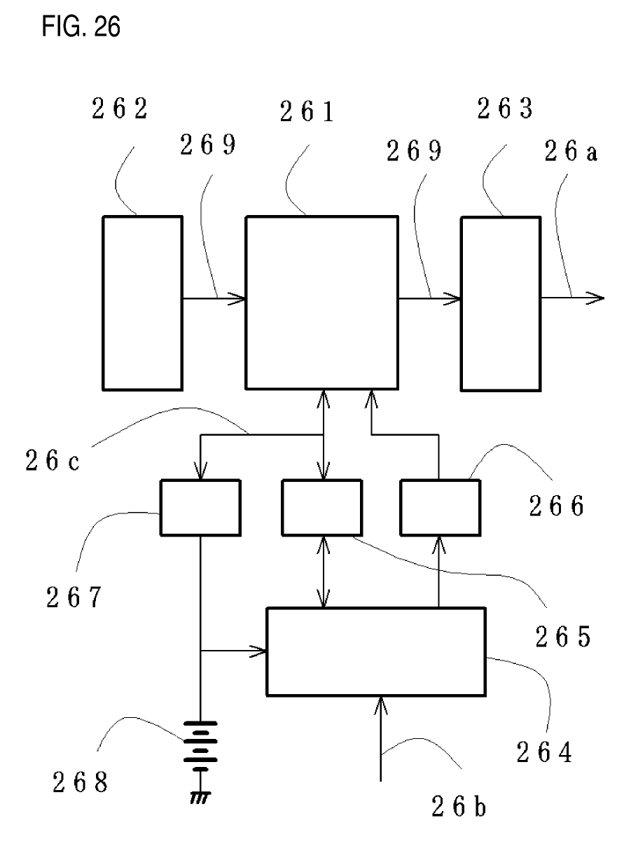

A rotating electric machine system according to a seventh embodiment of the present invention will be explained by using FIG. 26. The seventh embodiment is a rotating electric machine system which used the rotating electric machine apparatus of the third embodiment as a dynamo and an electric motor of a hybrid car.

In the figure, a number 261 shows the rotating electric machine apparatus shown in the third embodiment, and a rotary shaft 269 of the rotating electric machine apparatus 261 is combined so that torque may be transferred from engine 262 of a hybrid car and by a belt, and torque of rotary shaft 269 is transferred to drive shaft 26a through transmission 263. The control device 264 receives the instructions 26b from a higher rank control device, drives the rotating electric machine apparatus 261 as an electric motor through the drive circuit 265, and controls the magnetic field strength in the rotating electric machine 261 through the field control circuit 266. Furthermore, the control device 264 receives the instructions 26b from the higher rank control device, rectifies the electric power which appears in the output line 26c of the armature coils 86 through the rectifier circuits 267, and charges a battery 268.

The control device 264 drives the rotating electric machine apparatus 261 as an electric motor through the drive circuit 265 by directions of instruction 26b, and a revolution of engine 262 is assisted or, a revolution makes rotary shaft 269 drive independently, and contribute to the driving force of the hybrid car through transmission 263 and the driving shaft 26a.

When magnet torque needs to be strengthened in the low rotating speed region just after starting, the control device 264 drives pushrod 12e for right sides by actuator 12f, and makes the opposing area of the main magnetic pole 125 and the field magnet 124 larger so that the amount of the magnetic flux flowing between the magnetic teeth 84 and the magnetic salient poles 131, 132 becomes larger.

When magnet torque needs to be weakened in the high rotating speed region, the control device 264 drives pushrod 12e for left sides by actuator 12f, and makes the opposing area of the main magnetic pole 125 and the field magnet 124 smaller so that the amount of the magnetic flux flowing between the magnetic teeth 84 and the magnetic salient poles 131, 132 becomes smaller.

When the hybrid car can be driven only on the torque of an engine 262, the generated electric power which appears in the output line 26c of the armature coils 86 is changed into DC current through the rectifier circuits 267, and makes the battery 268 charge by the instruction 26b. In that case, the control device 264 controls the actuator 12f through the field control circuits 266 to become the optimal voltage that charges the battery 268. Since the rotating electric machine apparatus is used as a constant voltage dynamo, when charging the battery 268, the converter which changes power generation voltage is unnecessary. Furthermore, the expensive converter can be made unnecessary by controlling on the optimal power generation voltage for each battery, even when a battery 268 includes two or more sorts of batteries with different in its voltage.

The seventh embodiment functions effectively also as an energy recovery system at the time of braking of the hybrid car. When directions of regenerative braking are received through the instructions 26b, the control device 264 drives the push rod 12e rightward through the field control circuits 266, and makes the opposing area between the main magnetic pole 125 and the field magnet 124 larger, and then the amount of magnetic flux flowing between the magnetic teeth 84 and the magnetic salient poles 131, 132 larger, and generated electric power is made to charge to the battery 268. In having two or more batteries 268, the control device 264 controls the actuator 12f through the field control circuits 266, and controls the magnetic flux flowing between the magnetic teeth 84 and the magnetic salient poles 131, 132 so that the power generation voltage which suits the charge voltage of the battery 268 which has charge remaining power most is obtained. Since the rotating electric machine apparatus 261 is the physique employed as the electric motor for drive, so enough braking force can be generated as a generator for regenerative braking.

As described above, the rotating electric machine system of the present invention has been explained with reference to the embodiments. These embodiments are mere examples for realizing the theme or the purpose of the present invention and do not limit the scope of the invention. For example, although structures where an armature had magnetic teeth in the above-mentioned embodiments were shown. In the rotating electric machine of the conventional axial gap composition, the constructional example which does not arrange magnetic teeth also exists. Moreover, the armature composition example which arranges the printed armature coil on the cylindrical magnetic yoke and does not have magnetic teeth also exists in radial gap structure. This invention can be applied irrespective of the existence of magnetic teeth, and can adopt the optimal armature composition in accordance with the specification of rotating electric machine system. It is natural that a system for realizing the theme or the purpose of the present invention can be accomplished by combining the above-described embodiments or by combining some of the embodiments, and so forth.

### INDUSTRIAL APPLICABILITY

The rotating electric machine system has a separate magnetic excitation part to supply the magnetic flux to the magnetic salient poles, and the magnetic excitation part is composed so that the magnetic flux of the field magnet is controlled by mechanical displacement to be divided into magnetic flux pathways having the same magnetic resistances, and thereby, it becomes possible to control the field strength without the magnetic force to be an obstacle to the mechanical displacement.

The rotating electric machine system according to the present invention makes it possible to easily control the field strength between the rotor and the armature by changing the conventional structure in the vicinity of the magnet excitation of the rotating electric machine. The rotating electric machine system can be utilized as a high-power electric motor similarly to a conventional rotating electric machine, and additionally, enlarges the range of the practicable rotational speed, and furthermore, improves the function of the power generation, and also can control the power-generation function.

By applying the present invention as an electric generator and electric motor system for automobile application, the rotational speed range is able to be larger than the conventional one, and additionally, energy recovery in braking is enabled to improve the comprehensive energy consumption.

Furthermore, as the constant-voltage electric generator system, the power-generation voltage can be controlled to be constant in the wider rotational speed range, and therefore, the constant-voltage control circuit is not required, and furthermore, it becomes possible that a converter is not required for various types of battery charges in which voltages are different, and the entire system cost can be reduced.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed is:

1. A rotating electric machine apparatus comprising:
a surface magnetic pole part and an armature that are opposed to each other concentrically to an axis in a radial direction or in an axial direction and that are disposed to be capable of relatively rotating,
wherein the armature has an armature coil,
wherein the surface magnetic pole part has a plurality of magnetic salient poles disposed in a circumferential direction oppositely to the armature,
wherein the plurality of magnetic salient poles are classified to one group or two groups according to polarity(s) to be magnetized,
wherein each classified group(s) of the plurality of magnetic salient poles is magnetically excited by a magnetic excitation part,
wherein, in the magnetic excitation part, an end of a field magnet serves as a first magnet end and another end of the field magnet serves as a second magnet end and the first magnet end is opposed to a main magnetic pole and a bypass magnetic pole at least,
wherein the main magnetic pole is connected to a main magnetic flux pathway in which a magnetic flux circulates to the second magnet end through the plurality of magnetic salient poles and the armature,
wherein the bypass magnetic pole is connected to a bypass magnetic flux pathway in which a magnetic flux circulates to the second magnet end mainly in the magnetic excitation part,
wherein a magnetic resistance of the bypass magnetic flux pathway is set to be approximately equal to a magnetic resistance of the main magnetic flux pathway,
wherein the field magnet and a combination of the main magnetic pole and the bypass magnetic pole are composed so as to be capable of being relatively displaced so that a sum of an area of the first magnet end opposed to the main magnetic pole and an area of the first magnet end opposed to the bypass magnetic pole is maintained to be constant, and
wherein any one of the field magnet and the combination of the main magnetic pole and the bypass magnetic pole serves as a movable magnetic pole part, and the movable magnetic pole part is relatively displaced with respect to the other one thereof by a displacement control means, and thereby, an amount of the magnetic flux flowing into the main magnetic flux pathway is controlled.

2. The rotating electric machine apparatus according to claim 1,
wherein the magnetic excitation part includes one or more of the field magnet(s) disposed with one or more of non-magnetic portion(s) one after another in a circumferential direction, the main magnetic pole, the bypass magnetic pole, and the bypass magnetic flux pathway,
wherein the combinations each including the main magnetic pole and the bypass magnetic pole are composed to line side by side in a circumferential direction, oppositely to the first magnet end of each of the field magnet(s), and
wherein the main magnetic pole is connected to the main magnetic flux pathway in which a magnetic flux circulates to the second magnet end through the plurality of magnetic salient poles and the armature,
wherein the bypass magnetic flux pathway is a magnetic flux pathway in which a magnetic material and an air gap are magnetically connected between the bypass magnetic pole and the second magnet end and through which a magnetic flux circulates, and is composed so that an air gap length and an opposed area of the air gap in the bypass magnetic flux pathway can be adjusted to set a magnetic resistance of the bypass magnetic flux pathway to be approximately equal to a magnetic resistance of the main magnetic flux pathway, and
wherein the field magnet and the combination of the main magnetic pole and the bypass magnetic pole are composed so as to be capable of being relatively displaced in a circumferential direction so that a sum of an area of the first magnet end opposed to the main magnetic pole and an area of the first magnet end opposed to the bypass magnetic pole is maintained to be constant.

3. The rotating electric machine apparatus according to claim 1,
wherein the magnetic excitation part includes the field magnet with axial magnetization, the main magnetic pole and the bypass magnetic pole that have cylindrical shape,
wherein the main magnetic pole and the bypass magnetic pole are composed to line in an axial direction, oppositely to the first magnet end of the field magnet in a radial direction,
wherein the main magnetic pole is connected to the main magnetic flux pathway in which a magnetic flux circulates to the second magnet end through the plurality of magnetic salient poles and the armature,
wherein the bypass magnetic flux pathway is a magnetic flux pathway in which a magnetic material and an air gap are magnetically connected between the bypass magnetic pole and the second magnet end and through which a magnetic flux circulates, and is composed so that an air gap length and an opposed area of the air gap in the bypass magnetic flux pathway can be adjusted to set a magnetic resistance of the bypass magnetic flux pathway to be approximately equal to a magnetic resistance of the main magnetic flux pathway, and
wherein the field magnet and the combination of the main magnetic pole and the bypass magnetic pole are composed so as to be capable of being relatively displaced in an axial direction so that a sum of an area of the first magnet end opposed to the main magnetic pole and an area of the first magnet end opposed to the bypass magnetic pole is maintained to be constant.

4. The rotating electric machine apparatus according to claim 1,
wherein the surface magnetic pole part and the armature are opposed in a radial direction,
wherein the surface magnetic pole part is disposed in a rotor side and is composed so that the contiguous magnetic salient poles extend to different directions of a axial direction from each other and serve as a first extension part and a second extension part according to the extended axial direction, and
wherein the magnetic excitation part is disposed in the rotor and magnetizes the contiguous magnetic salient poles to be different polarities from each other through the first extension part and the second extension part.

5. The rotating electric machine apparatus according to claim 1,
wherein the surface magnetic pole part and the armature are opposed in a radial direction,
wherein the armature includes a magnetic yoke disposed around an axis, a plurality of magnetic teeth extending to a radial direction from the magnetic yoke and disposed in a circumferential direction, and the armature coil wound around the plurality of magnetic teeth,
wherein the surface magnetic pole part is disposed in a rotor side and is composed so that the contiguous magnetic salient poles extend to different directions of a axial direction from each other and serve as a first extension part and a second extension part according to the extended axial direction, and
wherein magnetic excitation parts are disposed on a stationary side of the rotor at both ends through an air gap, and the two magnetic excitation parts are connected magnetically between the first extension part and the magnetic yoke and between the second extension part and the magnetic yoke, respectively, so that the contiguous magnetic salient poles are magnetized to be different polarities from each other.

6. The rotating electric machine apparatus according to claim 1, further comprising a displacement regulating means for performing regulation so that a displacement of the movable magnetic pole part does not exceed a length that is a smaller one of a length of the main magnetic pole of the first magnet end side and a length of the bypass magnetic pole of the first magnet end side.

7. The rotating electric machine apparatus according to claim 1, further comprising a magnetic flux channel portion that is constituted from isotropic magnetic material with larger saturation magnetic flux density than saturation magnetic flux density of the magnetic salient pole, and is arranged in a far side region of the magnetic salient pole from the armature.

8. The rotating electric machine apparatus according to claim 1, further comprising an air gap and a gap length adjusting means in the bypass magnetic flux pathway,
wherein the gap length adjusting means may be adjusted to set a magnetic resistance of the bypass magnetic flux pathway to be approximately equal to a magnetic resistance of the main magnetic flux pathway.

9. The rotating electric machine apparatus according to claim 1, further comprising a predetermined constant current load,
wherein the predetermined constant current load is connected to the armature coil at a time of the displacement control of the movable magnetic pole part, and
wherein the predetermined constant current load makes a predetermined current flow in the armature coil by induced voltage so that magnetic resistance of the main magnetic flux pathway is adjusted effectively and magnetic force disturbing the displacement becomes small.

10. The rotating electric machine apparatus according to claim 1, further comprising a drive circuitry,
wherein the drive circuitry is connected to the armature coil at a time of the displacement control of the movable magnetic pole part, and
wherein the drive circuitry supplies a predetermined current to the armature coil for accelerating or decelerating a rotor so that magnetic resistance of the main magnetic flux pathway is adjusted effectively and magnetic force disturbing the displacement becomes small.

11. The rotating electric machine apparatus according to claim 1, further comprising:
means for detecting magnetic force by which magnetic resistance of the main magnetic flux pathway and the bypass magnetic flux pathway deviates from the predetermined condition and is added to the movable magnetic pole part,
means for supervising a relation between the magnetic force and intermittently connected constant current loads to the armature coil with different conditions, and
means for setting up the constant current load which makes the magnetic force smaller as the predetermined constant current load,
wherein, on an occasion of the displacement control of the movable magnetic pole part, the predetermined constant current load is connected to the armature coil so that magnetic resistance of the main magnetic flux pathway is adjusted effectively and magnetic force disturbing the displacement becomes small.

12. The rotating electric machine apparatus according to claim 1, further comprising:
means for detecting magnetic force by which magnetic resistance of the main magnetic flux pathway and the bypass magnetic flux pathway deviates from the predetermined condition and is added to the movable magnetic pole part,
means for supervising a relation between the magnetic force and intermittently supplied current into the armature coil with different conditions or a relation between the magnetic force and the supplied current into the armature coil during normal operation, and
means for setting up the current which makes the magnetic force smaller as the predetermined current,
wherein, on an occasion of the displacement control of the movable magnetic pole part, the drive circuitry supplies the predetermined current to the armature coil so that magnetic resistance of the main magnetic flux pathway is adjusted effectively and magnetic force disturbing the displacement becomes small.

13. The rotating electric machine apparatus according to claim 1, further comprising a mechanism to maintain a displacement position of the movable magnetic pole part in the displacement control means,
wherein control of the magnetic flux amount flowing into the main magnetic flux pathway is carried out intermittently.

14. The rotating electric machine apparatus according to claim 1,
wherein the surface magnetic pole part and the armature are opposed in an axial direction,
wherein the armature includes a magnetic yoke disposed around an axis, a plurality of magnetic teeth extending to an axial direction from the magnetic yoke and disposed in a circumferential direction, and the armature coil wound around the plurality of magnetic teeth,
wherein the surface magnetic pole part is disposed in a rotor side and is composed so that the magnetic salient pole and the non-magnetic portion are disposed one after another in a circumferential direction, and
wherein the magnetic excitation part is disposed in a static side or in a rotor side and is composed to supply a magnetic flux between the magnetic salient pole and the magnetic yoke.

15. The rotating electric machine apparatus according to claim 1,
wherein the surface magnetic pole part and the armature are opposed in a radial direction,
wherein the armature includes a magnetic yoke disposed around an axis, a plurality of magnetic teeth extending to a radial direction from the magnetic yoke and disposed in a circumferential direction, and the armature coil wound around the plurality of magnetic teeth,
wherein the surface magnetic pole part is disposed in a rotor side and is composed so that the magnetic salient pole and the non-magnetic portion are disposed one after another in a circumferential direction, and
wherein the magnetic excitation part is disposed in a static side or in a rotor side and is composed to supply a magnetic flux between the magnetic salient pole and the magnetic yoke.

16. The rotating electric machine apparatus according to claim 1,
wherein the surface magnetic pole part and the armature are opposed in a radial direction,
wherein each rotor has the surface magnetic pole part that a magnetic salient pole and a non-magnetic portion one after another,
wherein two rotors are disposed axially so that a magnetic salient pole of one rotor corresponds to a non-magnetic portion of the other rotor, and
wherein the magnetic excitation part is disposed in a static side or in a rotor side and magnetizes the magnetic salient poles of the two rotors to be different polarities from each other.

17. The rotating electric machine apparatus according to claim 1,
wherein the surface magnetic pole part and the armature are opposed in a radial direction,
wherein the surface magnetic pole part is disposed in a rotor side and is composed so that the magnetic salient pole and the non-magnetic portion are disposed one after another in a circumferential direction,
wherein the contiguous magnetic salient poles extend to different directions of a axial direction from each other and serve as a first extension part and a second extension part according to the extended axial direction, and
wherein the magnetic excitation part is disposed in a static side or in a rotor side so as to magnetize the contiguous magnetic salient poles to be different polarities from each other through the first extension part and the second extension part.

18. The rotating electric machine apparatus according to claim 1,
wherein the surface magnetic pole part and the armature are opposed in a radial direction,
wherein the surface magnetic pole part is disposed in a rotor side and is composed so that a magnetic salient pole and a permanent magnet with approximately circumferential direction magnetization are disposed one after another in a circumferential direction,
a magnetization direction of the contiguous permanent magnet is arranged inversely to each other so that the contiguous magnetic salient poles are magnetized in different directions to each other,
the contiguous magnetic salient poles extend to different directions of an axial direction from each other and serve as a first extension part and a second extension part according to the extended axial direction, and
one or two of the magnetic excitation part(s) is disposed in a static side or in a rotor side so that the direction of the magnetization whose permanent magnet magnetizes the magnetic salient pole and the direction of the magnetization whose excitation pole part magnetizes the magnetic salient pole through the first extension part and the second extension part are coincided.

19. The rotating electric machine apparatus according to claim 1,
wherein the surface magnetic pole part and the armature are opposed in a radial direction,
wherein a permanent magnet assembly which arranges a permanent magnet plate with same approximately circumferential direction magnetization on both sides of a magnetic material is an equivalent permanent magnet,
wherein the surface magnetic pole part is disposed in a rotor side and is composed so that a magnetic salient pole and the permanent magnet assembly are disposed one after another in a circumferential direction,
wherein a magnetization direction of the contiguous permanent magnet assemblies is arranged inversely to each other so that the contiguous magnetic salient poles are magnetized in different directions to each other,
wherein the contiguous magnetic salient poles extend to different directions of a axial direction from each other and serve as a first extension part and a second extension part according to the extended axial direction, and
wherein one or two of the magnetic excitation part(s) is disposed in a static side or in a rotor side so that the direction of the magnetization whose permanent magnet assembly magnetizes the magnetic salient pole and the direction of the magnetization whose excitation pole part magnetizes the magnetic salient pole through the first extension part and the second extension part are coincided.

20. A rotating electric machine system comprising:
the rotating electric machine apparatus according to claim 1; and
a control device;
wherein a rotational force is an input,
wherein the control device controls the displacement control means to set an opposed area between the first magnet end and the main magnetic pole to be smaller when a power generation voltage induced in an armature coil is larger than a predetermined value, and controls the displacement control means to set the opposed area between the first magnet end and the main magnetic pole to be larger when the power generation voltage is smaller than the predetermined value, and
wherein the power generation voltage is controlled to be a predetermined value.

21. A rotating electric machine system comprising:
the rotating electric machine apparatus according to claim 1; and
a control device;
wherein a current supplied to an armature coil is an input,
wherein the control device controls the displacement control means to set an opposed area between the first magnet end and the main magnetic pole to be smaller when a rotational speed is larger than a predetermined value and a field strength is weakened, and controls the displacement control means to set an opposed area between the first magnet end and the main magnetic pole to be larger when the rotational speed is smaller than the predetermined value and the field strength is enhanced, and thereby a rotational force is optimally controlled, and
wherein, when the rotational speed is reduced, the displacement control means is controlled so that the field strength between the armature and the surface magnetic pole part becomes larger, and thereby, the opposed area between the first magnet end and the main magnetic pole becomes larger to take out a rotational energy as a power generation output.

22. A method for controlling a magnetic flux flowing in an armature of a rotating electric machine apparatus that includes a surface magnetic pole part and an armature that are opposed to each other concentrically to an axis in a radial direction or in an axial direction and that are disposed to be capable of relatively rotating, the armature having an armature coil, the surface magnetic pole part having a plurality of magnetic salient poles disposed in a circumferential direction oppositely to the armature, the magnetic salient poles in the surface magnetic pole part are classified to one or two group(s) according to polarity(s) to be magnetized, and each of the classified group(s) of the magnetic salient poles are magnetically excited by a magnetic excitation part, said method comprising:
connecting, in the magnetic excitation part, a main magnetic flux pathway in which a magnetic flux circulates from one end of a field magnet to the other end of the field magnet through the magnetic salient poles and the armature and a bypass magnetic flux pathway in which a magnetic flux circulates from one end of the field magnet to the other end of the field magnet mainly in the magnetic excitation part to the field magnet in parallel;
setting a magnetic resistance of the bypass magnetic flux pathway to be approximately equal to a magnetic resistance of the main magnetic flux pathway so that total amount of magnetic flux from the field magnet is consistently maintained constant;
connecting, respectively, any one of the field magnet and the combination of magnetic poles to the main magnetic flux pathway and the bypass magnetic flux pathway to serve as a movable magnetic pole part; and
controlling an amount of magnetic flux flowing into the main magnetic flux pathway by relatively displacing the movable magnetic pole part with respect to the other one thereof by a displacement control means.

23. The method of controlling the magnetic flux flowing in the armature according to claim 22,
wherein interposing of a predetermined constant current load is connected to the armature coil at a time of the displacement control of the movable magnetic pole part, and
wherein the predetermined constant current load makes a predetermined current flow in the armature coil by induced voltage so that magnetic resistance of the main magnetic flux pathway is adjusted effectively and magnetic force disturbing the displacement becomes small.

24. The method of controlling the magnetic flux flowing in the armature according to claim 22,
wherein interposing of a drive circuitry is connected to an armature coil at a time of the displacement control of the movable magnetic pole part, and
wherein the drive circuitry supplies a predetermined current to the armature coil for accelerating or decelerating a rotor so that magnetic resistance of the main magnetic flux pathway is adjusted effectively and magnetic force disturbing the displacement becomes small.

25. The method for controlling the magnetic flux flowing in the armature according to claim 22, further comprising:
detecting magnetic force by which magnetic resistance of the main magnetic flux pathway and the bypass magnetic flux pathway deviates from the predetermined condition and is added to the movable magnetic pole part,
supervising a relation between the magnetic force and intermittently connected constant current loads to the armature coil with different conditions, and
setting up the constant current load which makes the magnetic force smaller as the predetermined constant current load,
wherein, on an occasion of the displacement control of the movable magnetic pole part, the predetermined constant current load is connected to the armature coil so that magnetic resistance of the main magnetic flux pathway is adjusted effectively and magnetic force disturbing the displacement becomes small.

26. The method for controlling the magnetic flux flowing in the armature according to claim 22, further comprising:
detecting magnetic force by which magnetic resistance of the main magnetic flux pathway and the bypass magnetic flux pathway deviates from the predetermined condition and is added to the movable magnetic pole part,
supervising a relation between the magnetic force and intermittently supplied current into the armature coil with different conditions or a relation between the magnetic force and the supplied current into the armature coil during normal operation, and
setting up the current which makes the magnetic force smaller as the predetermined current,
wherein, on an occasion of the displacement control of the movable magnetic pole part, the drive circuitry supplies the predetermined current to the armature coil so that magnetic resistance of the main magnetic flux pathway is adjusted effectively and magnetic force disturbing the displacement becomes small.

27. The method for controlling the magnetic flux flowing in the armature according to claim 22, further comprising:
maintaining a displacement position of the movable magnetic pole part in the displacement control means; and
carrying out the control of the magnetic flux amount flowing into the main magnetic flux pathway intermittently.
